(19) United States
(12) Patent Application Publication
(10) Pub. No.: US 2018/0173755 A1
(43) Pub. Date: Jun. 21, 2018

(54) PREDICTING REFERENCE FREQUENCY/URGENCY FOR TABLE PRE-LOADS IN LARGE SCALE DATA MANAGEMENT SYSTEM USING GRAPH COMMUNITY DETECTION

(71) Applicant: Futurewei Technologies, Inc., Plano, TX (US)

(72) Inventors: Yinglong Xia, Santa Clara, CA (US); Ting Yu Leung, Santa Clara, CA (US)

(73) Assignee: Futurewei Technologies, Inc., Plano, TX (US)

(21) Appl. No.: 15/470,830

(22) Filed: Mar. 27, 2017

Related U.S. Application Data
(60) Provisional application No. 62/435,606, filed on Dec. 16, 2016.

(51) Int. Cl. G06F 17/30

(52) U.S. Cl. CPC G06F 17/30454; G06F 17/30958; G06F 17/3053; G06F 17/30498; G06F 17/30486; G06F 17/30339

(57) ABSTRACT

Graph communities detection is used to separate out pre-load candidates that have a high probability of being needed or a high urgency for being quickly available from those with lesser probability and/or urgency. Pre-loads are performed for the candidate tables having the higher probability and/or higher urgency.

### CROSS REFERENCE

The application claims priority to U.S. provisional patent application 62/435,606 entitled PREDICTIVE TABLE PRE-JOINS IN LARGE SCALE DATA MANAGEMENT SYSTEM USING GRAPH COMMUNITY DETECTION”, filed Dec. 16, 2016 on behalf of inventors Yinglong Xia and Ting Yu Leung and is incorporated herein by reference in its entirety.

### BACKGROUND

Large scale data mining, which is sometimes referred to as “Big Data,” typically calls for real time maintenance of massive, enterprise level databases and use of numerous data analysis programs to extract currently meaningful information from the databases. The enterprise level databases typically store large numbers of relational tables that provide basic relational attributes for system tracked data objects (e.g., customers, products, employees, sales transactions, etc.). Data mining often calls for identification of complex correlations between system tracked data objects (e.g., which employees satisfactorily serviced which customers in a select class of sales transactions?) where some data objects are referenced more frequently than others.

These analyses typically call for different kinds of data referencings including those based on selective joining of data from multiple database tables and comparisons between data held by two or more tables, where some tables are referenced more frequently than others. Emerging challenges in this area include quickening the rate at which Big Data mining results are produced and making efficient use of finite data processing and storage resources (e.g., high speed memory). One method of achieving these goals is to rely on predictive pre-processing wherein certain data processing operations that are likely to be required when the data analysis programs execute are carried out before program execution and judiciously stored so that the results are substantially immediately available for use by currently executing programs. One such form of predictive pre-processing is known as a pre-join operation. Here, tables that are to be selectively joined together inside an analysis program (even if contingently) are joined together ahead of time. Another method of achieving shorter analysis times is that of pre-storing more often (although not always) used data in higher speed storage. This access acceleration technique is sometimes referred to as pre-loading.

Traditional database pre join and pre-load determination techniques exhibit poor performance when the number and/or sizes of tables increases significantly. Improved methods and systems are disclosed here.

### BRIEF SUMMARY

In an embodiment, a computer-implemented method is provided for identifying within a database-using system, candidate database tables that are to be pre-loaded into local storage. The method comprises: producing and recording a graph having edges and nodes, the nodes representing identified tables and the edges representing table referencing operations; computing respective importance values for respective ones of the table-representing nodes, the importance values being indicative of at least one of how many operations are predicted to reference each respectively represented table, weights of frequency and/or urgency pre-assigned to the operations represented by node-contacting edges and pre-computed importance values of ancestors or progeny nodes of each respective node within the graph; partitioning the recorded graph into a plurality of graph communities having respective community densities, the densities being indicative of each respective graph community having one or more nodes of relatively high importance; and identifying, as preferred candidates for pre-loading, the tables represented by those of the nodes having a greater importance as compared to importance values computed for other nodes in the partitioned graph.

In another embodiment a data processing system is provided comprising memory storage comprising instructions; and one or more processors in communication with the memory, wherein the one or more processors execute the instructions to: generate a graph having edges and nodes, wherein each node represents a respective table and each edge represents a respective table referencing operation; compute a respective importance value for each of the nodes, the importance value being indicative of at least one of how many operations are predicted to reference each respectively represented table, weights of frequency and/or urgency pre-assigned to the operations represented by node-contacting edges, or pre-computed importance values of ancestors or progeny nodes of each respective node within the graph; partition the recorded graph into a plurality of graph communities having respective densities, the densities being indicative of each respective graph community having one or more nodes of relatively high importance; and identify, as preferred candidates for pre-loading, the tables represented by those of the nodes having a greater importance as compared to importance values computed for other nodes in the partitioned graph.

In another embodiment, a non-transitory computer-readable medium is provided storing computer instructions, that when executed by one or more processors, cause the one or more processors to perform the steps of: generate a graph having edges and nodes, wherein each node represents a respective table and each edge represents a respective table referencing operation; compute a respective importance value for each of the nodes, the importance value being indicative of at least one of how many operations are predicted to reference each respectively represented table, weights of frequency and/or urgency pre-assigned to the operations represented by node-contacting edges, or pre-computed importance values of ancestors or progeny nodes of each respective node within the graph; partition the recorded graph into a plurality of graph communities having respective densities, the densities being indicative of each respective graph community having one or more nodes of relatively high importance; and identify, as preferred candidates for pre-loading, the tables represented by those of the nodes having a greater importance as compared to importance values computed for other nodes in the partitioned graph.

In another embodiment according to any of the preceding embodiments, the represented tables include those that are participants in multi-table referencing operations such as pre-join operations.

In another embodiment according to any of the preceding embodiments, the weights of respective ones of the edges is based on metadata associated with the respective edges, the metadata indicating at least one of a join type, join dynamics, probability of the join being referenced, geometry of the join, directional aspect of the join, frequency of reference to the join results, historical trends in frequency of reference to the join results and urgency priority for having the join results immediately available.

In another embodiment according to any of the preceding embodiments, the associated metadata of respective ones of the edges provide a unique identification for the corresponding edge and/or its represented set of one or more join operations.

In another embodiment according to any of the preceding embodiments, the associated metadata of respective ones of the edges identify the tables joined by the respective edge.

In another embodiment according to any of the preceding embodiments, the nodes are respectively associated with corresponding node metadata, the node metadata indicating at least one of a unique node identification, an identification of a table represented by the node, an identification of a table type, an indication of the table size, an indication of maximal extents in different aspect dimensions of axes of the table, an indication of how persistent the table needs to be within memory and an indication of a desired access speed for accessing the table.

In another embodiment according to any of the preceding embodiments, before the partitioning of the produced graph there is carried out at least one of a filtering of the produced graph to leave behind only edges representing a specific one or more of different operation types; and a filtering of the produced graph to leave behind only nodes representing a specific one or more of different types of tables.

In another embodiment according to any of the preceding embodiments, the identifying of the preferred candidates comprises ordering detected graph communities according to their graph densities, where the densities are indicative of collective importance of nodes therein, frequency of referencing to the members of the community and/or indicative of collective urgency of access to the members of the community; and identifying a densest one of nodes within one of the ordered graph communities.

In another embodiment according to any of the preceding embodiments, there is carried out a sequencing from one of the ordered graph communities to the next based on said ordering.

In another embodiment according to any of the preceding embodiments, the identifying of the preferred candidates comprises: determining if a pre-load candidate is larger than a predetermined threshold, and if yes, designating the corresponding pre-load candidate for partitioning into smaller sequential predictive pre-processing candidates.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of a queries processing system including at least one of a pre-loading and pre-computing capability.

FIG. 1B is a schematic diagram depicting a method based on graph analysis for planning and performing at least one of pre-loading or pre-computing operations.

FIG. 1C is a schematic diagram depicting a storage performance pyramid and depicting placement (pre-load) of referenced tables into different layers of the pyramid.

FIG. 1D is a schematic diagram depicting an elementary graph having two nodes linked to one another by a connector branch while one of the nodes is further contacted by a monotonic referencing operation (a unitary table use graph edge).

FIG. 1E is a schematic diagram depicting a given enterprise within a world environment and usages of database tables by data mining applications of the enterprise.

FIG. 2A is a schematic diagram depicting a graph structure in accordance with the present disclosure having nodes representing database tables and links or spokes representing different kinds of referencing operations such as table join operations and table select, table truncate or other such operations.

FIG. 2B is a results graph after community detection.

FIG. 3 is a flow chart depicting the procedures for identifying pre-join candidates.

FIG. 4 is a flow chart depicting a method for picking out preferred pre-joins to perform.

FIG. 5 is a flow chart depicting a method for partitioning left behind pre-join candidates.

FIG. 6 is a flow chart depicting a method of using pre-joins in place of performing join operations in real time during execution of database-using applications.

FIG. 7 is a block diagram depicting three types of operatively interconnected engines of a system in accordance with the present disclosure.

### DETAILED DESCRIPTION

The present disclosure relates to pre-run-time judicious loading (pre-loading) of data into different types of local storage. The different types can include a relatively higher speed but smaller sized storage (e.g., a local fast cache) and a relatively slower speed but larger capacity storage (e.g., local disk storage). Pre-loading into various forms of local storage contrasts with an alternative where data needed during run-time resides only in even slower and remote memory during run-time and as such, run-time fetching of that remotely-stored data is required. The run-time fetching may consume excessive amounts of time and of resources (e.g., network bandwidth resources). Pre-loading can avoid these issues.

The present disclosure additionally relates to pre-run-time judicious carrying out of certain computations that involve pre-joining of database tables or other multi-table operations followed by judicious pre-loading of the pre-join results.

In accordance with one aspect of the disclosure, graphs are automatically generated to include nodes (also referred to herein as graph “vertices”) that each represents a database table and to include branches (also referred to herein as graph “edges”) that each represents an operation on one or more database tables. While some branches may represent operations (e.g., truncate) that work on only a single table, other branches may represent operations (multi-table operations, e.g., join) that simultaneously operate on a plurality of tables. The uni-table operations may be represented by single contact branches that emanate from respective table-representing nodes as spokes from a hub without nodes attached at their other ends while the multi-table operations may be represented by multi-contact branches (also referred to herein as graph “connectors”) that connect together the two or more nodes on whose represented tables the represented operations work.

In accordance with an aspect of the disclosure, the automatically generated graphs include branch metadata indicating the likelihood of and/or predicted frequency for run-time execution of the corresponding uni- or multi-table operation. In accordance with an alternate or additional aspect of the disclosure, the branch metadata indicates an urgency for quick run-time execution of the corresponding operation.

In accordance with an aspect of the disclosure, the automatically generated graphs include node metadata indicating predicted table size and table access importance. The predicted table size may indicate a predicted size for the result of a join operation where the tables to be joined are of variable sizes or the predicted size for the result of a truncate operation where the table to be truncate or the extent of truncation is a variable. The table access importance may indicate how important it is for the corresponding table to be present during run-time within a specific kind of local storage (e.g., fast cache) and/or within a pre-categorized set of local storage resources (e.g., those with read speed greater than a pre-specified threshold).

In accordance with an aspect of the disclosure, the automatically generated graphs are automatically partitioned into graph communities in accordance with graph densities, for example in accordance with graphed densities of assigned importances of inter-related nodes (e.g., nodes that couple one to another by way of a relatively small number, say 5 or less of serially successive graph edges). The graph communities are sorted in accordance with their respective graph densities and/or node importance densities. Communities with the highest graph and/or importance densities are considered first for potential pre-loading of their respectively represented tables so that the pre-load operation brings together into local fast cache and/or other suitable types of high speed local memory those of the tables that are likely to be simultaneously needed during run-time in high speed local memory in order to gain benefit of pre-loading. (It does little good to pre-load all but one of simultaneously needed tables and then wait a long time during run-time for fetching from slow remote memory of the last of the simultaneously needed tables. Thus, in accordance with an aspect of the disclosure, simultaneously needed tables are collectively pre-loaded based on their collective level of assigned importances.)

In accordance with an aspect of the disclosure, table importances are determined using a PageRank type of importance redistribution algorithm where initial importance of child nodes in the graph may increase importance of parent nodes and importance of parent nodes may percolate down to increase importance of other child nodes. The child to parent and parent to child percolation of importance values may be iteratively carried out many times until a relatively stable distribution of importances is settled upon. Other aspects of the disclosure will become apparent from the following more detailed description. An advantage of one or more of the disclosed methods is that tables most worthy of being pre-loaded can be quickly identified and changes over time to operations carried out by the system can be easily reflected as corresponding modifications made to the graphs. Means are disclosed herein for generating graphs, for assigning weights to graph edges and/or graph nodes indicative of initial importances, for recalculating node importances based on graph connections, for identifying graph communities, for ordering the graph communities based on node importances and densities of important nodes and for identifying the more important nodes in the more important communities as prime candidates for pre-loading.

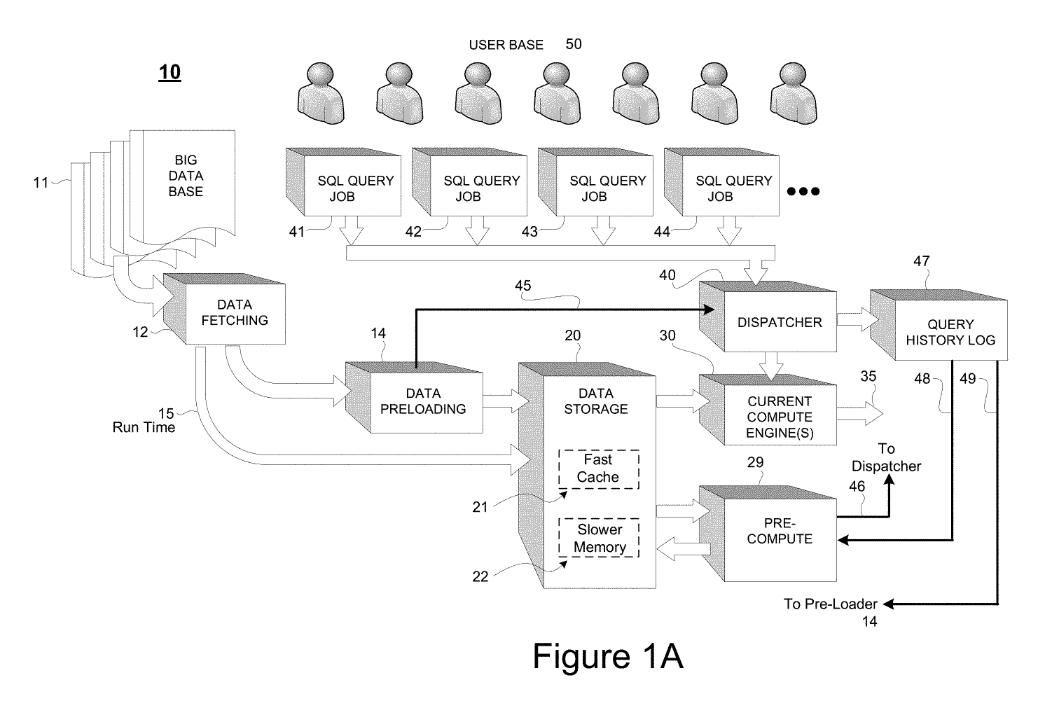

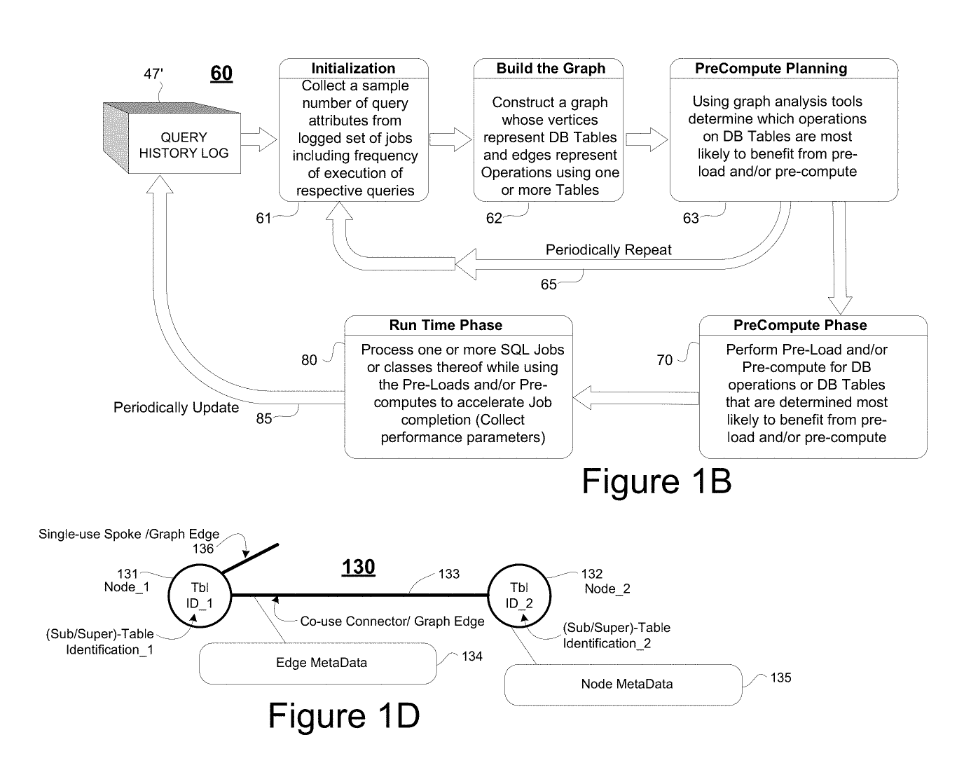

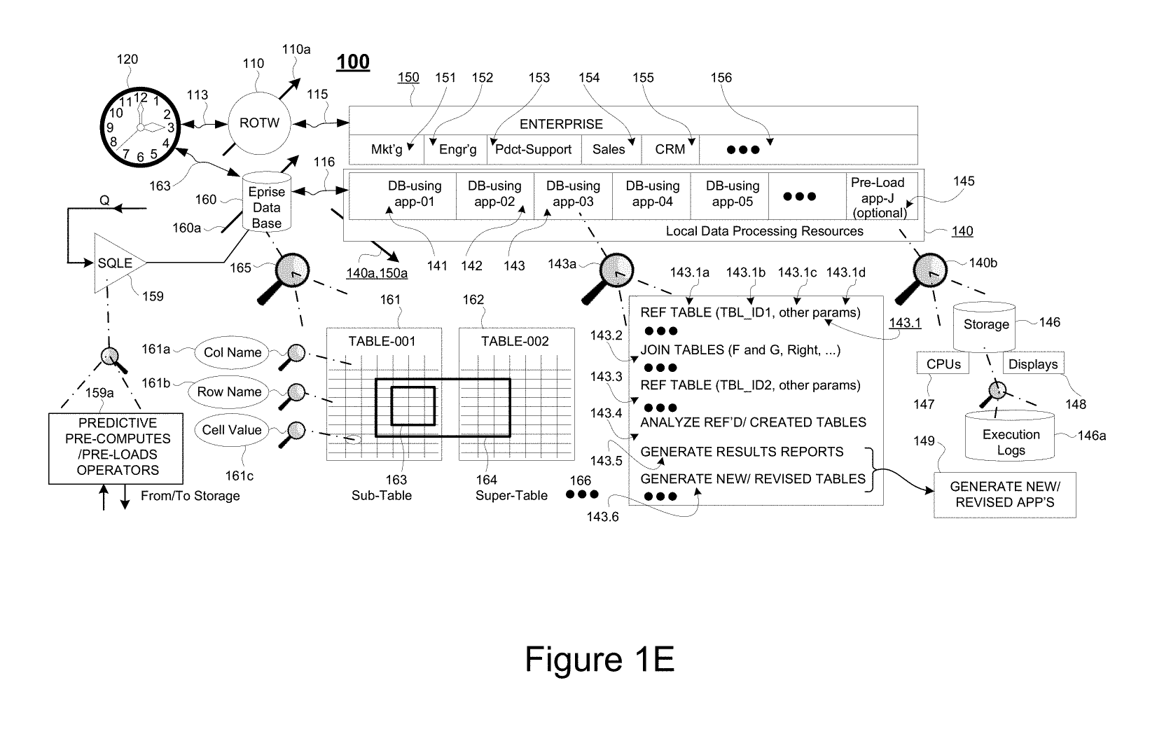

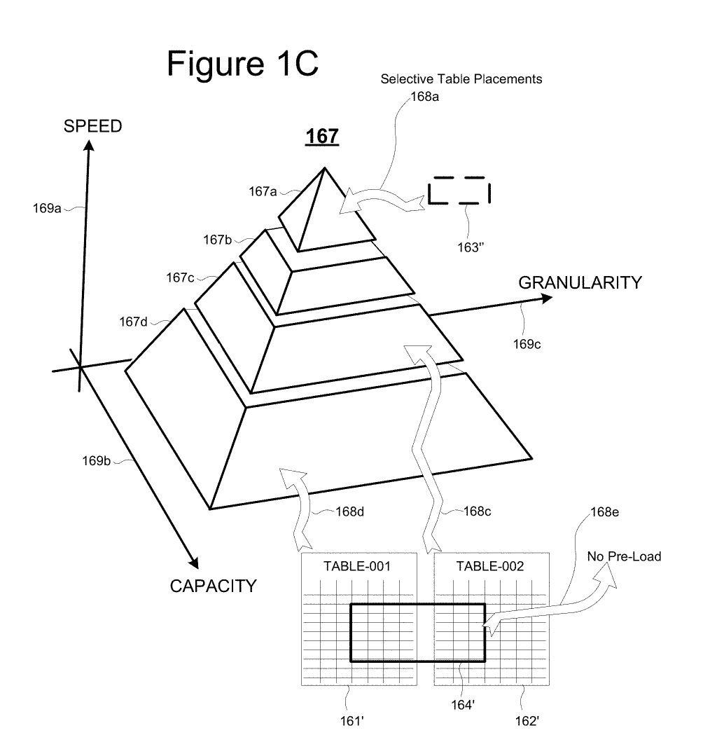

Referring first however to FIG. 1A, shown is a block diagram of a queries processing system 10 including at least one of a pre-loading capability 14 and a pre-computing capability 29. Ideally, each of the pre-loading (14) and pre-computing (29) operations should provide a current compute operation (30) with corresponding pre-load and/or pre-compute results on an efficient, just-in-time basis so that through-put of the current compute operation is maximally increased and portions of local data storage 20 allocated for storing pre-load and/or pre-compute results are not wasted storing large amounts of data that are not soon to prove useful for current compute operations (30). Additionally, the data processing resources of the pre-loading capability 14 and of the pre-computing capability 29 should not be wasted on generating large amounts of data that are not soon to prove useful for current compute operations (30).

A problem in the field of predictive pre-processing (e.g., pre-loading and pre-computing) is how to determine which pre-process results are most likely to be most beneficial to those of compute operations 30 that are most likely to soon execute in the queries processing system 10. This is not a trivial problem in large scale systems that for example have many users 50 and large numbers of query jobs (e.g., 41-44, etc.) to run within predetermined time slots.

Further details of FIG. 1A are described here for sake of more complete understanding. Large scale data mining or “Big Data” for short, typically calls for real time maintenance of massive, enterprise level databases collectively illustrated in FIG. 1A as a Big Data Base 11. This massive amount of Big Data 11 might be measured in terabytes or petabytes and is generally too large to be stored in a single storage unit that can provide reasonably fast access to any random part of the system. Accordingly, selective fetching and moving (12) of needed data from the Big Data Base 11 to a relatively localized storage subsystem 20 should be performed. This selective fetching and moving (12) can be performed at run time (15) in real-time response to data requests made by currently executing query jobs (e.g., 41-44, etc.) or it could be carried out on a predictive pre-process basis even before the currently executing query jobs ask for the data. The latter predictive and selective fetching and moving of not-yet-known-to be-needed-for-sure data is automatically performed by the data pre-loading unit 14. Thereafter, when a currently executing query job asks for the data, if it is found to already be present in local storage 20, time is not wasted sending a selective fetch request to the data fetching unit 12 and waiting for the requested data to be found in the Big Data Base 11 and moved during run time (15) and over network resources (not explicitly shown) into the local storage 20.

A subsidiary aspect of pre-loading (14) is that of determining where in local storage 20 the pre-loaded data should be stored. For sake of simplicity, the exemplary local storage subsystem 20 is shown subdivided into just a fast cache portion 21 and a slower memory portion 22. Other aspects of storage subdivision will be discussed below in conjunction with FIG. 1C. It is within the contemplation of the present disclosure to subdivide a local storage subsystem into many more portions than just fast and slower parts (e.g., 21, 22). The utilized subdivisions may have not only different read and/or write speed attributes but also other different attributes such as with respect to nonvolatility, longevity, reliability, security and so forth. The illustrated binary subdivision in FIG. 1A is merely for sake of a simple example.

Similar to how it may be advantageous to selectively pre-load (14) certain items of data, it may be advantageous to compute ahead of time (before run-time) certain data processing results even before it is known that such data processing results will actually be needed. More specifically, the need for some run-time data may be contingently based on other run-time results. If the system pre-compute unit 20 predicts with relatively good accuracy what data processing results the currently executing query jobs (e.g., 41-44, etc.) will likely soon need to generate, then the pre-compute unit 20 can generate those results ahead of time (for cases where pre-compute is feasible), store them in the local storage 20 and thereafter, when one or more of the currently executing query jobs (e.g., 41-44, etc.) discovers that it needs those results, the query job can first check a pre-computes directory (not shown) to see if the needed results have been pre-computed. If yes, time and resources need not be consumed computing those results again and again. A subsidiary aspect of pre-computing (29) is that of determining where in local storage 20 the pre-computed data should be stored. Once again for sake of simplicity, the choice might be a binary one of deciding between the local fast cache portion 21 and the slower local memory portion 22. In other embodiments (see FIG. 1C) the menu for possible storage placements may be more complex.

In accordance with the present disclosure, a job dispatcher 40 is operatively coupled to one or more run-time compute engines 30. The dispatcher 40 determines when and which SQL query jobs (e.g., 41-44, etc.) should be dispatched for current execution by a respective one or more run-time compute engines 30. The dispatcher 40 may make its decisions based on a variety of factors including, but not limited to, how big each job is, what resources (e.g., free run-time compute engines in 30, free memory space in 20) are currently available for servicing that job, and the urgency of getting the job done (e.g., as indicated by job priority weights—not shown). Optionally, the dispatcher 40 may make its decisions based on one or both of respective indications 45 and 46 respectively from the pre-loading unit 14 and the pre-compute unit 29 as to what pre-loads and/or pre-computes are currently loaded into the local data storage resources 20 (and which ones, 21 or 22) for accelerating the completion time of each candidate job or for accelerating the completion time of a class of jobs to which a current candidate job (e.g., 41-44, etc.) belongs. Thus the speed with which each submitted query job (e.g., 41-44, etc.) gets completed (as finished output 35) may depend on how well the predictive pre-processing units, such as the pre-loading unit 14 and the pre-compute unit 29, accurately predict which pre-processings (e.g., pre-loads and/or pre-computes) should be placed into the local data storage resources 20 and when and where within those resources (e.g., 21 or 22).

In one embodiment, the job dispatcher 40 is operatively coupled to a query history logging unit 47. The logging unit 47 respectively provides feedback information streams 48 and 49 respectively to the pre-compute unit 29 and the pre-loading unit 14 for informing the latter units of what query jobs (e.g., 41-44, etc.) or classes thereof were recently submitted (e.g., within the past hour, day, week, etc.) and with what respective frequencies (e.g., per hour, per day, per week, etc.) and/or respective urgencies (e.g., high, medium, low) as well as optionally indicating trends and what errors or slow downs were encountered as a result of missed pre-processing opportunities (e.g., missing pre-loads and/or missing pre-computes). The pre-compute unit 29 and the pre-loading unit 14 can then adaptively learn from this feedback information (48 and 49) so as to perform better in view of changing needs of the user population 50.

Referring to FIG. 1B, shown is a schematic diagram depicting a method 60 based on graph analysis for planning and performing predictive pre-processing, for example at least one of pre-loading and pre-computing operations. In an initialization step 61, the method obtains recent performance data from the query history logging unit 47′. The obtained data may be that for a predetermined set of recently performed (e.g., within the current week, biweek, month etc.) query jobs or a predetermined one or more classes of recently performed query jobs (e.g., those dedicated to servicing specific needs of specific enterprise departments—see briefly 151-155 of FIG. 1E). In one embodiment, the obtained data includes at least one of recent frequency of execution of the query jobs in the predetermined set or predetermined one or more classes of the query jobs and recent urgencies (e.g., priorities) of the query jobs. The obtained data may alternatively or additionally include trending data indicating recent rates of increase or decrease in frequency of execution of the query jobs or in urgencies of the query jobs.

In step 62, a multi-branch modeling graph is automatically built based on the obtained recent performance data. The constructed graph includes vertices (or nodes) respectively representing database (DB) tables and branches (or edges, lines or connectors) respectively representing operations performed on branch-touched ones of the represented DB tables (e.g., 131 and 132 of FIG. 1D).

In step 63, graph structure analysis tools are used to automatically determine which operations on which DB tables are most likely to occur in the near future (e.g., within the current hour, day, week etc.) such that execution of corresponding query jobs in the near future are more likely than not to benefit (e.g., in terms of completion speed and/or resource utilization efficiency) by taking advantage of predictive pre-processing opportunities (e.g., pre-loading of the more frequently involved DB tables and/or pre-computing the more frequently and/or more urgently need results of represented operations). The graph structure analysis tools may include those that identify dense clusters (dense graph communities) of nodes and branches (a.k.a. vertices and graph edges). In one embodiment, a cluster of nodes and branches is considered relatively dense when the number of nodes is relatively small (e.g., less than 16) and weights attributed to the nodes and/or their interconnecting branches exceed corresponding predetermined thresholds. Other or additional definitions may be used for what portions of a generated graph are to be considered or not as dense graph communities. In one embodiment, definitions for what portions of respective generated graphs are to be considered or not as dense graph communities are heuristically determined based on experience and automated machine learning. As will be seen below, different mixtures of importance may be assigned to operation-representing branches and table-representing nodes depending on what types of predictions are being made (e.g., based on probability and/or urgency of having certain data pre-loaded and/or pre-computed for respective kinds of jobs).

In step 70, the corresponding pre-loads and/or pre-computes of the represented tables and operations, as identified by the graph structure analysis tools to be more likely to benefit are carried out. In one embodiment, one or more benefit metrics are devised and the pre-run-time operations (pre-loads and/or pre-computes) that provide the most benefit are carried out first.

In step 80 (run-time phase), corresponding query jobs or classes of query jobs that are deemed to be more urgent and/or most likely to benefit from available results of carried out predictive pre-processings (e.g., pre-loads and/or pre-computes) are executed. At substantially the same time, performance metrics of the executed jobs are collected and used to periodically update (85) the queries history log kept in unit 47′. Then, after one or more updates (85) of the queries history log have been made, a repeat 65 of steps 61, 62 and 63 is carried out so as to create an updated performance modeling graph and a correspondingly updated set of predictive pre-processing (e.g., pre-load and/or pre-compute) plans. As mentioned, in one class of embodiments, definitions for what portions of respectively generated graphs are to be considered or not as dense graph communities are heuristically determined based on experience and automated machine learning. In this way, the system can automatically adapt to changing conditions.

A more detailed explanation is now provided with reference to FIG. 1E where the latter is a schematic diagram depicting a real world environment 100 including a given enterprise 150 that makes use of accessible (fetchable) database tables such as 161 and 162 that are stored in an enterprise accessible database 160. Use of the tables can include analysis of data stored in those tables (e.g., 161, 162) during execution of enterprise-accessible data mining applications such as illustrated at 141, 142 and via magnification 143a of application program 143. The various data mining applications may utilize table aggregation operations (e.g., table join operations such as at 143.1), table simplification operations (e.g., truncate operations not shown) and table comparison operations to generate respective analysis reports (such as those of step 143.5) relevant to current world and current enterprise situations. Various activity units (e.g., 151, 152, etc.) of the enterprise 150 may make use of these generated reports including that of timely reacting to real world events inside the enterprise 150 and/or in the rest of the world (ROTW) 110. Due to the rapid rate at which events can unfold, it can be highly useful to obtain real time analysis reports (143.5) as soon as possible (ASAP), meaning that the database-using applications should perform their operations as quickly as possible. Additionally, because more than one analysis report may be desired at the same time, each database-using application should minimize its use of scarce resources (e.g., network bandwidth, fast cache) so that such scarce resources can be efficiently shared among many applications.

Yet more specifically, as real world time and events rapidly unfold (represented by clock symbol 120), current situational conditions within the enterprise 150 and/or within the rest of the world (ROTW) 110 can change both interdependently and independently of one another at commensurate rates. Data held in corresponding database tables can change accordingly. Double arrow headed symbol 115 represents interdependent interactions between events inside the enterprise 150 and those of the ROTW 110. Double arrow headed symbol 113 represents predicted event unfoldings (modeled future events) of the ROTW 110 including, for one embodiment, predicted futuristic market conditions and sales projections. A first angled through-arrow 110a in the diagram that extends through ROTW symbol 110 represents over-time variability of external world conditions. A second angled through-arrow 140a-150a that extends through block 140 represents over-time variability of enterprise internal conditions including those of enterprise activity units (e.g., 151-156) and those of enterprise controlled data processing resources 140. A third angled through-arrow 160a represents over-time variability of enterprise accessible database resources 160 including over-time variability of tables and table data maintained by the enterprise accessible database resources 160.

One point being made in the above and with reference to the various through-arrows (100a, 140a-150a, 160a) is that everything is constantly changing (although not all at the same rates) and thus accommodations should be made for such continuously evolving enterprise-internal and external conditions. By way of example, if the exemplary enterprise 150 is a business enterprise selling specific goods and/or services to a given one or more market segments then that enterprise 150 should be keeping track of demographic and other changes (both current and predicted) within its target customer population and also keeping track of competitive forces (both current and predicted) exerted by competing other enterprises (not referenced but understood to exist within ROTW bubble 110. It is to be understood that at least some of the competitors may also be using database analysis to further their competitive stances. Thus part of the competition involves getting the analysis results at least as fast as do the prime competitors of the given exemplary enterprise 150. To that end, the given business enterprise 150 may rely on both general purpose and proprietary data mining applications (e.g., 141-143) for repeatedly sifting through the enterprise-accessible, big data database 160 (can be more than one database) while using local or remotely accessible data processing resources 140, 159, 160 of, or accessible to, the enterprise to perform automated analysis. It is to be noted that enterprise accessibility to the one or more databases 160 is schematically represented by double-headed arrow symbol 116 in FIG. 1E. Yet another double-headed arrow symbol 163 in the diagram represents predictive models maintained within the big database 160 or within other enterprise-accessible storage (e.g., 146) for predicting likely world outcomes for the enterprise 150 and for the ROTW 110 based on currently available information and current analysis of that information (e.g., that provided by the analysis programs 141, 142, etc.).

In one exemplary embodiment, the illustrated business enterprise 150 includes: (a) a marketing unit or department 151 that is responsible for predicting future market demands and price affordabilities of target customer populations; (b) an engineering unit 152 responsible for designing goods and/or services for serving current and predicted market needs; (c) a product support unit 153 responsible for supporting current products and/or services offered by the enterprise; (d) a sales unit 154 responsible for making offers and sales to the customer population; (e) a customer relations management (CRM) unit 155 responsible for tracking and forming desired relationships with current and prospective customers and yet further such business units or departments where the latter are represented by ellipses 156.

Each of the operational units (e.g., 151-156) of the enterprise 150 may make use of one or more database-using application programs (e.g., DB-using apps 141-143, . . . ). The programs themselves (e.g., 143) may each make use of one or more table referencing and/or table aggregation operations which are typically performed by an accessible query engine such as SQLE 159. More specifically and referring to the magnified look 143a at some of the executable instructions inside application 143, it may be seen that a subset of these instructions can call for a number of table referencing operations (e.g., to be performed by SQLE 159) such as represented at 143.1, 143.2 and 143.3. Yet more specifically, a first of the illustrated table(s) referencing instructions, 143.1 includes an SQL referencing command 143.1a (which in the SQL language may take the form of a SELECT command for example). Parameters of the table(s) referencing instruction 143.1a may include: an identification 143.1b of one or more tables that are possibly to be targeted by the instruction 143a.1 and yet other parameters 143.1c, 143.1d which may specify a specific form of referencing, specific fields to be referenced and/or various conditional constraints on or for carrying out the table referencing instruction. More specifically, in one example shown at line 143.2 the specified SQL instruction is a JOIN instruction which calls for conditional (contingent) joining of certain tables (e.g., tables F and G); an identification of the type (e.g., Right) of join operation to be performed and further parameters, for example a conditions expression (not shown, represented by ellipses) where the latter expression might include one or more contingencies (e.g., IF X is true and Y is false) that are to be satisfied before the specified type of join operation is commenced. In accordance with one aspect of the present disclosure, a probability value or score (not shown) is automatically attached to such conditional expressions based on expert knowledge base rules held (and optionally heuristically updated) in a predetermined knowledge base (not explicitly shown but can be stored in database 160 for example) that is maintained for indicating current probabilities of execution of various instructions such as instructed tables joins (e.g., 143.2). In other words, the scores indicate the likelihood that the respectively instructed operations (e.g., join operations) will be carried out if the respective instructions (e.g., 143.1, 143.2, 143.3) were to be currently executed or executed in the near future (e.g., a handful of hours or days later). In one embodiment, the expert knowledge base rules may also indicate respective urgencies for respectively instructed operations to be carried out based on the types of analysis applications within which those instructed operations are embedded.

It may be appreciated by those skilled in various search query languages such as SQL that join operations can come in many different flavors including cross joins; natural joins; inner joins; outer joins; equi-joins; full joins and self joins to name a few. The example given at instruction line 143.2 for a Right join is merely by way of nonlimiting illustration and it is within the contemplation of the present disclosure to account for most or all of such different table join operations and/or other table(s) referencing operations. e

The result of a join operation is the creation of a new table having one or more of columns and rows selectively acquired from its parent tables. In the present disclosure, the term “table” is to be broadly construed as having one or more columns (e.g., 161a) and one or more rows (e.g., 161b) where a minimalist table may consist of a single cell (e.g., 161c) having a corresponding named column and named row. The cell itself may be devoid of a value (nil) or may store a value corresponding to its named column and named row. Stored values may be numeric in nature, alphabetic (e.g., text) in nature or otherwise and may have different formats. It is understood that when tables are joined, one of the underlying operations may be one that normalizes the column and/or row specifications so that the values in the new table resulting from the join are consistent. For example, it might be inappropriate to have some first numeric values representing kilograms and yet others representing grams in a column specifying a product weight (e.g., for rows specifying different products, where the column is to specify their comparable weights).

When table creating operations such as a join or crop operation is carried out, the resulting new table may be smaller in size (in terms of one or both of number of rows and number of columns) than one or more of its parent tables. An example of such a smaller or sub-table is shown at 163. On the other hand, the result of a creation (e.g., join) operation may produce a new table having more rows and/or more columns than at least one of its parent tables. An example of such a larger or super-table is shown at 164 where, although not explicitly shown, the number of columns can be greater than that of either parent table (e.g., 161 and 162). For some join or other creation operations, the resulting new table may have the same dimensions as each of its parent tables or it may have the sum of the row and column dimensions of its parent tables. Stated otherwise, the tables resulting from various table creation, manipulation, join or other operations can have different sizes depending on the specifics of the operations. In accordance with one aspect of the present disclosure, the determinable or probable size of a new or revised table resulting from a given operation is taken under consideration when deciding whether to perform a pre-load operation (note block 159a which is part of SQLE 150) and deciding where to pre-load the table (e.g., a pre-joined table) before corresponding table(s) referencing instructions are executed (e.g., by SQLE 150) on behalf of one or more of the database-using applications (e.g., 141-143).

Before executing a table(s) referencing operation, the engine 150 automatically checks a directory (not shown, but could be inside storage 146 or in database 160) to see if a currently-usable pre-join or other table revision has already been performed, for example by an engine maintained predictive pre-processing operation (e.g., a pre-joining application—not shown, but could reside inside pre-compute block 159a) and then pre-loaded into appropriate local storage area (see briefly FIG. 1C) by an enterprise or engine maintained pre-loading application or service (e.g., 145). System performance speed and efficiency can be improved by relying on pre-run-time created pre joins and pre-loads rather than executing separate remote data fetches, separate join or other table revising operations (e.g., truncate operation) each time each engine performed operation needs the corresponding join or other creation result during run time. Also system performance speed and efficiency can be improved by relying on judicious pre-placement of tables in different parts of a system's local storage pyramid (see briefly FIG. 1C) rather than storing all tables in the system's largest capacity but slowest access layer (e.g., 167d) among its storage resources. However, system performance speed and efficiency may suffer if inappropriate subsets of tables are pre-joined (e.g., ones not needed at all or ones needed only infrequently) and/or if pre-compute results are stored in inappropriate layers (e.g., 167d of FIG. 1C) of system's faster storage resources, for example by consuming capacity in a high speed, smaller sized storage layer like 167a of FIG. 1C for a table (e.g., 164″) that is referenced very infrequently and/or on a less than urgent basis. In other words, inefficiencies may be created and resources may be wasted if system resources (e.g., storage 146/167 and/or data processing bandwidth 147/169a) are inappropriately consumed for creating predictive pre-processing results that are rarely if at all needed and/or if created pre-compute results are stored in less than optimum parts of the system storage pyramid (see briefly 167 of FIG. 1C) based on the rate at, and/or urgency with which such stored predictive pre-processing results will be called for when the query operations are executed (after predictive pre-processing time). A problem is how to efficiently and timely determine (e.g., during pre-processing time) which predictive pre-processing operations (e.g., pre-joins, pre-loads) are desirable and which may be undesirable (e.g., wasteful of system resources) and how to determine where in the system storage pyramid (e.g., 167 of FIG. 1C) to store them.

Still referring to FIG. 1E, in instructions area 143.4 of the exemplary magnification 143a of one of the DB-using apps, one or more of new or revised tables that have been earlier formed by one or more of the conditional table(s) creation/modification instructions (e.g., 143.1-143.3) are analyzed. Instructions within area 143.4 may call for further conditional table(s) creation/modification instructions of two or more of the new/revised tables formed by previous instructions (e.g., 143.1-143.3). The latter new/revised tables may be further analyzed and so on. Thus it is possible to generate large numbers of newly-created/modified (e.g., truncated, cropped) tables having sizes smaller and/or larger than or the same as the initial base tables (e.g., 161-162) obtained from the database 160. Depending on complexity and size (as well as memory access latency), significant amounts of system time and system resources may be consumed in forming the various new/revised tables produced by respective ones of the database-using applications (e.g., 141-143). Thus it is valuable to have one or more pre-processing operations (e.g., carried out in predictive pre-processing block 159a) that lessen burdens on the system during live compute times (during analysis and report generation times) where the predictive pre-processing operations can easily scale to handle large numbers (e.g., thousands, hundreds of thousands) of pre-processing possibilities and to identify the ones that are best suited for pre-processing in light of continuously evolving enterprise internal and external situations (whose over-time variabilities are represented by 140a, 150a, 160a and 110a). It is also valuable to have one or more pre-processing results placement applications or services (e.g., 145) that are designed to automatically and judiciously place predictive pre-processing results (pre-joins, pre-truncates, etc.) in appropriate parts of the system storage pyramid (e.g., 167 of FIG. 1C) based on predicted frequency of use and/or predicted urgency for speed and/or predicted granularity of data size during access.

Still referring to FIG. 1E, in instructions area 143.5 of the exemplary magnification 143a, result reports based on the carried out analyses 143.4 are generated. In instructions area 143.6, new or revised tables are generated based on the carried out analyses 143.4. Either one or both of the generated reports (143.5) and generated new or revised tables (143.6) may result in one or more follow-up activities of creating even newer or further-revised analysis programs such as is indicated in follow-on block 149. The created new analysis programs of block 149 would form part of the variability 140a of the system by being added into the set of the latest database using applications (e.g., 141-143) already present within the data processing resources 140 of the enterprise 150. The newly created analysis programs may call for new table creations/revisions (e.g., joins, truncates) different than those of the previous applications (e.g., 141-143) and/or may use same table creations/revisions as those called for by the previous applications (e.g., 141-143). In turn, decisions with respect to what pre-processings to conduct and where to store the pre-processing results (e.g., in pyramid 167 of FIG. 1C) may vary over time.

It is to be understood from FIG. 1E that in addition to the database using applications (e.g., 141-143), the data processing resources accessible to the enterprise 140, 160 may include yet other resources as illustrated through magnification 140b where those other resources can include but are not limited to local and remote data storage resources 146 (e.g., both high speed, fast access small capacity ones and slower speed, slower access, larger capacity ones—to be explicated below in discussion of FIG. 1C), local and remote central processing units (CPU's) and/or other such data processing units 147 and machine-user interfaces including information displaying interfaces such as indicated at 148. Among the data storage resources of the enterprise there will be storages of system logs including execution logs 146a that contain information of when, where and how often in recent history (e.g., past 6 months) various ones of the database using applications (e.g., 141-143) were run and which operations (e.g., 143.2, 143.3) each application did or did not execute (successfully or otherwise). In one embodiment, the execution logs 146a may include traces indicating the identities of created/revised tables (e.g., newly formed join tables) and the types of the creations/revisions (e.g., left, right, or full joins); indicating their respective sizes and/or number of columns and number of rows (or average or median such dimensions); and indicating which executing applications (e.g., 141-143) created those newly formed join tables and how often the various applications were executed and/or with what relative magnitudes of urgency/priority. In accordance with the present disclosure, these types of logged data may be used to construct usage-representing graph structures whose descriptive data is automatically repeatedly stored and/or updated within system memory (e.g., within storage 146).

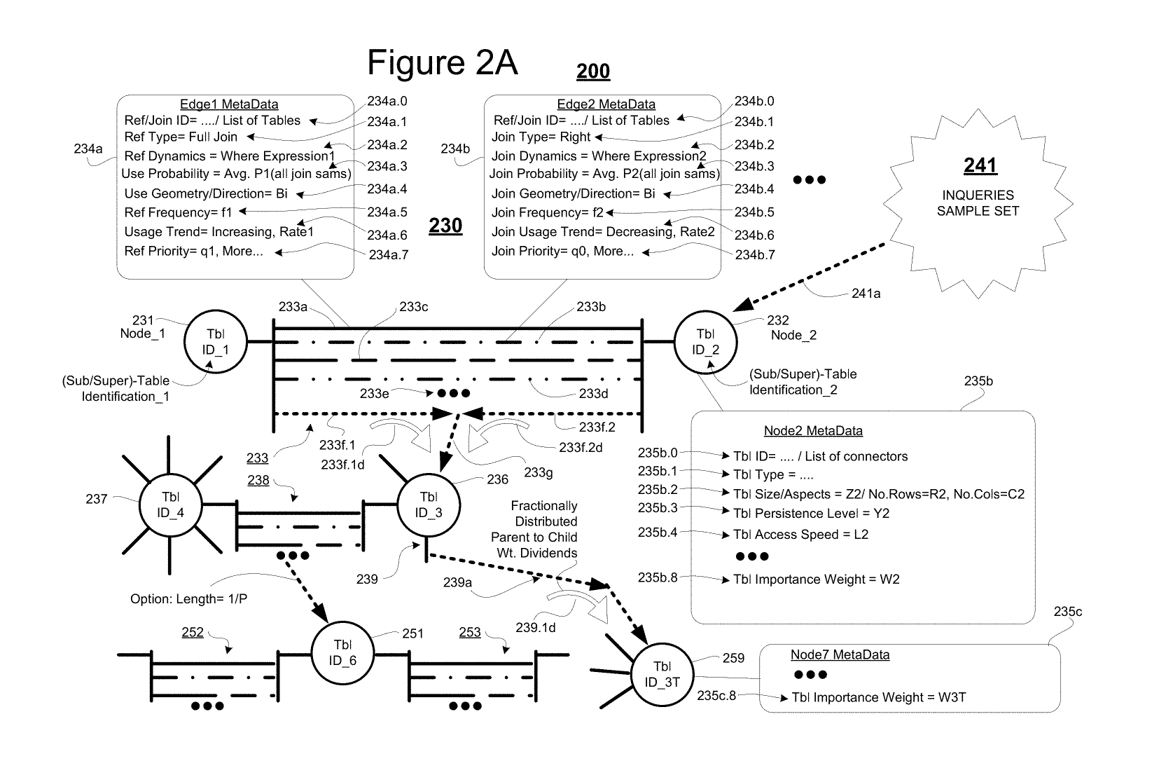

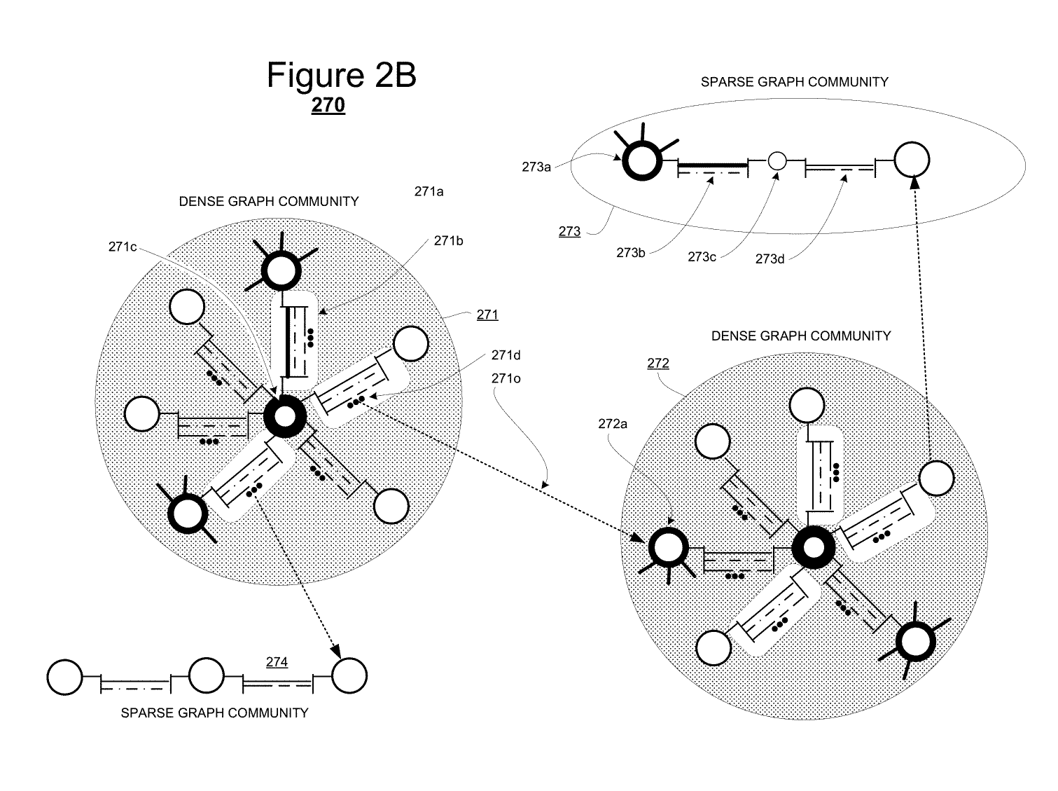

Referring to FIG. 1D, shown is an elementary graph structure 130 having a nodes joining connector branch 133 representing a join instruction (which optionally can be a contingent join that is executed only if certain pre-specified conditions are met). The output of the represented join instruction 133 (assuming the instruction is indeed executed) is not shown in FIG. 1D. (See instead 233g of FIG. 2A.) Node 131 represents a first table (or sub-table, or super-table) identified within the join instruction 133 of FIG. 1D as a candidate for joining. Node 132 represents a second table (or sub-table, or super-table) identified within the instruction 133 as a candidate for joining. Although FIG. 1D assumes a binary join operation, it is within the contemplation of the present disclosure to alternatively graph aggregation instructions which join together or otherwise collectively operate on more than two identified tables. In the latter case, connector branch 133 might be shown in the form of two or three lines (branches) coming together at a juncture point (e.g., as a triad). Each of the nodes (e.g., vertices 131, 132) and instruction-representing connector branch (or edge) 133 of the graph structure 130 has associated metadata stored on its behalf to represent relevant attributes of that graph structure element. In the case of the connector branch's metadata 134 (also to be referred to as graph edge metadata 134) it is shown to be logically linked with the respective connector branch 133. The included metadata (not yet shown in detail) of edge metadata 134 may comprise identifiers of the node or nodes (e.g., 131, 132) disposed at respective terminal ends of that connector branch 133, an identification of the type of aggregation or other operation to be performed (e.g., full, left or right join) and an identification or description of conditional parameters of the aggregation or other operation instruction including at least one parameter indicative of the probability that the aggregation or other operation instruction will be executed and/or the urgency for it to be executed. Exemplary graph edge 136 represents a predicted operation that references only one table (e.g., that of node 131). Although not shown, that single referencing spoke 136 will have its own edge metadata similar to 134 of edge 133.

The node metadata (e.g., 135) of each respective node (e.g., 132) may include an identification of the respective table (or sub-table, or super-table; e.g., Tbl_ID_2) that the node represents; an indication of the table size (or probable table size) and/or of extents of its respective two or more dimensional axes (although 2D tables are used as examples, the disclosure also contemplates tables of greater dimensionalities); an indication of how many instruction-representing connector branches (e.g., 133) or other graph edges (e.g., 136) connect to that node (could be 0), an identification of one or more of the connector branches or other edges (if any) that connect to the node and an identification of a type of storage (e.g., fast read/write cache versus slow disk) where the data of the represented table is planned to be stored.

For one graphic user interface (GUI) in accordance with an embodiment of the present disclosure that displays the exemplary graph structure 130, the metadata of the respective elements (nodes/graph-vertices and connectors/graph-edges) are not normally displayed, but may be shown when the user hovers a cursor or other pointer over the element and/or clicks on that element. In the same or an alternate GUI environment, connectors/edges (e.g., 133) whose represented instructions (e.g., a join instructions) have relatively high probabilities of being carried out (and/or relatively high urgencies for being carried out) are represented as correspondingly thick connector lines while branches of other instructions having relatively lower probabilities of execution (or low urgencies for execution) are represented as correspondingly thinner lines. In the same or an alternate GUI environment, nodes (e.g., 131) whose represented tables (e.g., Tbl_ID_1) have sizes falling within a predetermined and preferred range of table sizes and/or whose represented tables are planned to be stored in a predetermined and preferred type of data storage (e.g., fast DRAM) and/for whose represented tables are connected to by a number of branches (e.g., 133) greater than a predetermined threshold are represented by icons (e.g., internally colored and/or shaded circles, triangles, squares etc.) having greater density (and/or closeness to darker hues) than other icons used for representing other tables whose attributes fall outside of one or more of the preferred ranges. Thus when a user views the graph structure on such a GUI, some clusters of nodes and respective connectors/graph-edges will appear as relatively denser and/or more darkly colored while other nodes/graph-vertices and respective connectors/graph-edges will appear as belonging to sparsely populated and/or lightly colored regions of a composite graph structure (see briefly FIG. 2B).

FIG. 2A depicts in more detail an example of a composite graph structure 230 that may be used in an automated predictive pre-processing (e.g., pre-join and/or pre-load) planning system 200 in accordance with the present disclosure. The graph structure 230 is initially populated only with nodes representing explicitly named, base tables found in a sample set 241 of the database using applications (e.g., 141-143 of FIG. 1E). Here, the base tables are those that are explicitly stored in the enterprise-accessible database 160 rather than other tables that are to be formed on the fly for example during run time by join, truncate or other such table creating operations. The sample set 241 of database-using applications may be picked based on any of a number of sample size limiting conditions. The number of pre-processing operations (e.g., pre-joins and pre-loads) that are performed should be limited because there is a point of diminishing returns where some pre-joins and/or pre-loads are too large, too small or so infrequently used that consumption of system memory space and consumption of system execution bandwidth is not worth the time savings later attained at run time when the corresponding application programs call for the respective predictively pre-processed results. Among the sample size limiting conditions that may be used for defining the sample set 241 are: (a) the frequency of execution of each candidate application within a predetermined recent duration of time (e.g., last week, last six months); (b) the number of enterprise departments and/or users launching each candidate application within a predetermined duration of time (e.g., last three months); (c) priority weights assigned to each of the candidate applications with respect to the importance of the results and/or required speed by corresponding departments/users where the assignment occurred within a predetermined duration of time (e.g., last month); (d) user/department priorities assigned to a top N using departments or users of each of the candidate applications (where N is an integer such as in the range 2-10); and (e) time for completion of each of the candidate applications where a long time of completion is attributed to logged table aggregation operations within those applications.

After the composite graph structure 230 is populated by the base tables (represented as nodes), the sample set 241 of database using applications is scanned to determine which join, truncate or other such table creating and/or referencing instructions touch on each of the explicitly named base tables. Corresponding branch, edge or connector elements (e.g., connectors set 233 having different connector subsets 233a, 233b, 233c, etc.) and other graph edge elements (e.g., spokes like 239) are added to the composite graph structure 230 to represent the found join, truncate or other such table creating or otherwise referencing instructions. In FIG. 2A, subsets of different types of join operations (e.g., full, right, left, etc.) are depicted by different types of dashed or non-dashed lines. By way of example, solid line 233a represents a first subset of join instructions whose corresponding metadata is shown at 234a. Meta-data entry 234a.0 can provide one or both of a unique identification for a corresponding subset of joins represented by the connector 233a and a link to, or list of the tables joined by that represented connector 233a (e.g., Tbl_ID_1 and Tbl_ID_2). Meta-data entry 234a.1 can indicate the joint type (e.g., Full) of the corresponding subset of joins represented by the connector 233a. Meta-data entry 234a.2 can indicate other join parameters (e.g., types of Where expressions) of the corresponding subset of joins represented by the connector 233a. Meta-data entry 234a.3 can indicate an average probability or range of probabilities (e.g., Min, Max and median) for the corresponding subset of joins represented by the connector 233a. Note that each connector line (e.g., 233a) will typically represent a plurality of join instructions for the given joint type (indicated by 234a.1) where each of the join instructions has a respective probability of being actually executed (e.g., due to its join dynamics 234a.2). The composite of those probabilities of execution for the sampled set 241 of inquiries will have a corresponding one or more composite probability parameters such as an average probability, a median probability, a minimum probability and a maximum probability. These may be listed in metadata field 234a.3 and afterwards used to determine whether a pre-join should be performed.

Additionally, the respective branch metadata 234a of exemplary graph edge/connector 233a may include one or more entries 234a.4 indicating the geometry and/or direction (or non-directiveness) of the represented branch. A typical branch may be a binary one with just two terminals, one at each end, and each connecting to a respective table node (e.g., 231 and 232) and it will typically be non-directional. However, it is within the contemplation of the present disclosure to have hub and spokes connector structures with three or more spokes each terminating at a respective table node. It is also within the contemplation of the present disclosure to represent connectors some or all of whose spokes have specified directions. In one example, the resultant outputs of a represented set of join operations (2330 may be represented by a directional output spoke (a table creation spoke) as depicted at 233g. In one embodiment, the length of each directional output spoke is graphed as being proportional to or otherwise functionally related to the reciprocal of the average or median probability of the represented set of join or other table referencing operations (e.g., L=k*1/P or f(k, 1/P)). Thus, the output spokes of more the more likely to be executed join instructions will be graphed as relatively short and will produce correspondingly dense graph structures (see briefly 271 of FIG. 2B) while the output spokes of less likely to be executed join instructions will be graphed as being relatively long and will produce correspondingly sparse graph structures (see briefly 274 of FIG. 2B).

Still referring to FIG. 2A, yet another meta-data entry 234a.5 may indicate the relative frequency (e.g., f1) or number of occurrences of the represented set of join instructions within a correspondingly predetermined recent duration of time (e.g., last few weeks). This relative frequency indicator (e.g., f1) or number of occurrences indicator (T/f1) may be derived from a logged number of times that a sampled application program of sample set 241 was executed during a predetermined recent length of time (e.g., past two weeks) and/or from a logged number of times that the join operation or a subset thereof is used in the sampled application program.

A further metadata entry 234a.6 indicates trending information for the represented subset of join operations, for example whether they are increasing or decreasing over a predetermined recent duration of time (e.g., past week) and optionally the rate of change. This trending information may be used as part of a determination as to whether to perform the represented pre-join operation (e.g., a full join of Tbl_ID_1 and Tbl_ID_2) or not.

Yet additional metadata entries 234a.7 may be provided for use in making the determination as to whether to perform the represented pre-join operation (e.g., a full join of Tbl_ID_1 and Tbl_ID_2) or not. One example may be an average of join priorities assigned to the represented subset of joins (of connector 233a) based on the importance of having the pre-join results readily available as quickly as possible. Another prioritizing weight (not shown) may indicate an average or median of user/department priorities assigned to the top N enterprise departments or users that use the represented join operation. Although not explicitly shown, it is within the contemplation of the present disclosure to provide one or more weight parameters (e.g., w1, w2, etc.) Within the metadata 234a of the respective connectors where these one or more weight parameters are functions of one or more elemental characteristics of the connector, the elemental characteristics including but not limited to: frequency or popularity of usage within one or more predetermined time durations; urgency of quick result availability within one or more predetermined time durations; access priority assigned to one or more users or departments that have made use of the join results within one or more predetermined time durations; and so on. The below described determination of whether or not to perform a corresponding pre-join can be based on one or more of these weights.

Referring to a second illustrated connector symbol 233b, its corresponding edge metadata is shown at 234b. Similar reference numbers in the range of 234b.0 through 234b.7 are shown for that corresponding block of metadata 234b and a repeat of these details is not necessary except to note that the join type indicated at 234b.2 for this subset of found instructions is a right join rather than a full join as was the case for counterpart entry 234a.2.

Yet further subsets of same type join operations may be represented by yet other connectors such as 233c shown for the set of connectors 233 interposed between nodes 231 and 232. For example the join type for the subset of joins represented by connector 233c might be a Left join as opposed to the right join specified at 234b.1 and the full join specified at 234a. 1. It is within the contemplation of the present disclosure that either or both of a Right join and a Left join may be covered by performance of a Full pre-join since Left and Right joins are subsets of a full join. Accordingly, in one embodiment, after an initial determination of which pre joins to perform, the results are scanned for duplicate efforts; for example one specifying both a left join and a full join of the same tables and redundant pre-joins are eliminated; for example deleting a left join when the same results are included within a full join of the same tables.

Further types of subsets of joins are represented by connector line 233d and . . . 233e. An example of a tri-spoked connector is shown at 233f where spoke 233g directionally links to the result of the join operation; that result being a new table Tbl_ID_3 represented at node 236. Result outputting spoke 233g may have its own metadata (not shown) where the latter includes an indication of the probability of result 236 being created. The created new result table (represented by node 236) may be found to be an input member of further sets of join operations including the typed subsets indicated at 238 (where the counterpart table for binary joins is represented in node 237 as Tbl_ID_4). The further sets of join operations (e.g., 238) may lead to yet further likely creations of additional tables (e.g., Tbl_ID_6 represented at node 251) where such additional tables 251 may be touched by yet further connector sets as shown for example at 252 and 253.

Tables are not referenced and/or created merely by join operations. Another example of table referencing and/or creating is a table truncate operation where one such conditional table truncate operation is represented by spoke-like branch 239 emanating from node 236 (Tbl_ID_3) in FIG. 2A. If the conditional table truncate operation 239 is carried out, then its output 239a produces a truncated table (Tbl_ID_3T) as represented in FIG. 2A by node 259. Further conditional or unconditional table referencing operations may be carried out on the conditionally created truncated table 259 as represented by further spoke-like branches emanating from that node 259. Each node (including those which do not participate in join operations) has respective node metadata stored for it (e.g., logically associated with it).

Referring to the respective node metadata block 235b of corresponding table node 232 (representing Tbl_ID_2), a first of the meta-data entries 235b.0 may provide a unique identification (Tbl_ID) for the respective table and/or a list of connectors or connector spokes that terminate at that represented table. A further metadata entry 235b.1 may indicate the type of the table. By way of non-limiting examples, database tables may have different schemas and/or dimensionalities and are not necessarily limited to the two dimensional (2D) examples illustrated here. A corresponding metadata entry 235b.2 may indicate the size of the table (e.g., Z2) in terms of consumed bytes and/or numbers of data elements. The corresponding metadata entry 235b.2 may alternatively or additionally indicate the dimensional aspects of the table such as in terms of the number of rows (e.g., R2) held within the table and the number of columns (e.g., C2) held within the table. In accordance with one aspect of the present disclosure, the size of a table resulting from a join operation is taken into account when determining whether or not to perform a corresponding pre-join operation. For example, it may be automatically determined that the resulting table is too large in size and two infrequent in its logged usage history to warrant consuming limited system storage (e.g., 146) and consuming limited system data processing resources (e.g., 147) just to have a pre-performed join result of that one, too large and relatively infrequently used table (e.g., Tbl_ID_2).

Yet other node metadata entries such as illustrated at 235b.3 may indicate how persistent the represented table is expected to be. More specifically, the output results of certain pre-join operations may be kept in system storage for relatively long periods of time because many database-using applications (e.g., 141-143) are expected to use the pre-join results over predicted long periods of time while in counterpoint, output results of other pre join operations may be predicted to be kept in system storage for substantially shorter periods of time because only a few, short-lived database-using applications are expected to use those other pre-join results. The data persistence information of entry 235b.3 may be useful in determining when to perform a pre-join operation and when to allow the data of that pre-join operation to be overwritten by the data of a later performed pre join operation.

Additional node characterizing metadata, such as represented at 235b.4 may indicate the data access latency (e.g., L2) of the resultant table. For example, if the table is sufficiently small (e.g., size=Z2) it may be practical to store that table in a high-speed cache memory so that the results of the pre-join operation can be quickly accessed and used. This information may contribute affirmatively to the decision of whether or not to perform a pre-join operation that results with the node characterized table. As indicated by the ellipses in the block 235b, yet further metadata may be stored for characterizing the table represented by the corresponding node 232.

Importantly and in accordance with the present disclosure, each node characterizing metadata block further stores at least one node “importance” or weight factor such as shown at 235b.8 of block 235b of node 232 and such as shown at 235c.8 of block 235c of node 259. The one or more node “importance” or weight factors of each node are used in one embodiment for determining if and where to pre-load the data (the table) of the corresponding node within a system-defined hierarchy of allocated pre-load storage resources, as will be described shortly with respect to FIG. 1C. Although FIG. 2A illustrates just one respective importance weight factor (e.g., W2, W3T) for each node, it is within the contemplation of the present disclosure to have a variety of respective importance weight factors for each respective node where one of the plural importance weight factors is reflective of frequency of referencing to that node and/or to its children or partners (where percolation from progeny will be explained below) while a second of the plural importance weight factors is reflective of urgency of referencing to that node and/or to its children/partners and a third of the plural importance weight factors is reflective of a composite of the first and second factors or is reflective of another attribute that renders the respective node important or less so for weight-based placement in the system defined hierarchy of allocated pre-load storage resources (e.g., 267 of FIG. 1C). It is to be understood that the importance factors (e.g., 235b.8, 235c.8 of FIG. 2A) need not be the only factors considered when performing weight-based placement in the system defined hierarchy of allocated pre-load storage resources. Competitive table size can be a factor as well. The latter aspect may consider whether a placement candidate can fit in a remaining portion of the system defined hierarchy of pre-load storage resources and if so, at the expense of which other smaller candidates that might make better use of the remaining portion. This aspect of the disclosure will be re-visited later below.

Referring to FIG. 1C, shown is an example of a system defined hierarchy 167 of allocated pre-load storage resources. In the illustrated example just one storage pyramid 167 is shown exploded apart into respective layers 167a-167d having progressively increasing storage capacity (represented by relative width as projected along the capacity axis 169b) and progressively decreasing storage access speed (represented by position along the speed axis 169a, where read and write and over-network or data bus transmit speeds are not necessarily the same and could appear separately on different dimensional axes). Although not shown, additional characterizing axes of the illustrated multidimensional space (the one having axes, 169a, 169b, 169c) might include one or more of a cost axis, a security axis, a reliability axis and a latency axis. The disclosure is not limited to 2D or 3D characterization of pre-load storage resources. It is within the contemplation of the present disclosure to have additional storage representing structures (not all necessarily shaped as pyramids) with same or different characterizing attributes where, for example, a second such pyramid (not shown) might represent storage resources disposed physically adjacent to a remote set of one or more processors (not shown) while the illustrated first storage pyramid 167 represents storage resources disposed physically adjacent to a local set of one or more processors (not shown). In the latter and merely exemplary case, preload placement would not be merely a function of storage speed and capacity but also of pre-planning with respect to where the corresponding data processing would occur while using which of storage resources disposed in different physical locations and having respective same or different other attributes.

As seen in the example of FIG. 1C, an exemplary third axis 169c of a multidimensional attributes space indicates granularity of addressable storage units. More specifically, in the given example the highest layer 167a of the storage pyramid 167 might represent in-chip or on-board cache memory that can provide extremely fast read and/or write access to the corresponding one or more processors (not shown) that are to perform a planned data access operation (e.g., reference a truncated table) but whose addressable memory units are of relatively fine granularity; for example 64 KBytes apiece. Thus if the planned data access operation needs to access at least 640 KBytes (as an example) it might have to sequentially reference ten separate ones of the addressable memory units of the storage layer 167a, thus perhaps negating whatever speed advantage that highest layer 167a initially appears to offer. Therefore it is to be appreciated that placement decisions (for where pre-loads should go) are not necessarily made on the basis of speed (169a) and/or capacity (169b) alone but rather can be made on the basis of a multitude of storage characterizing attributes including, but not limited to, addressing granularity (169c), cost, security, reliability, nonvolatility, latency. In one embodiment, placement decisions are automatically made based on expert knowledge base rules held in a predetermined knowledge base (not explicitly shown but can be stored in database 160 for example) that is maintained for indicating optimal placement options based on currently used storage characterizing attributes, currently remaining storage space in each of the storage layers (e.g., 167a-167d), probabilities of execution time need for the respective candidates for pre-loading, relative importances of execution time need for the respective candidates for pre-loading and so on.

For sake of completeness for the given example 167, while uppermost layer 167a might represent cache memory, next layer 167b might represent slightly slower but bigger SRAM memory, where the next below layer 167c might represent slightly slower but bigger DRAM memory equipped with battery backup for providing a certain degree of nonvolatility to data stored therein and the yet next below layer 167d might represent slower but significantly bigger FLASH and/or disk storage memory that provides an even greater degree of nonvolatility for data stored therein. Although not indicated, some of the storage options may include in-cloud versus local storage options where the associated data processing options for these different kinds of storage may similarly be disposed in-cloud or locally.

FIG. 1C also shows an example of possible pre-load placement decisions. In the illustrated example it is decided by automated means (e.g., using IF . . . THEN . . . ELSE conditional rules of an expert knowledge base system) that table 161′ is relatively ‘important’ but also relatively big and thus should be pre-loaded into storage layer 167d as indicated by placement symbol 168d. Similarly, it is decided by automated means table 162′ is relatively more ‘important’ and therefore it should be pre-loaded into storage layer 167c as indicated by placement symbol 168c. It is further decided by automated means that truncated table 163′ is relatively most ‘important’ and therefore it should be pre-loaded into the uppermost storage layer 167a as indicated by placement symbol 168a. However, it is yet further decided by automated means that joined table 164′ is relatively not ‘important’ and therefore it should not be pre-loaded as indicated by non-placement symbol 168e.

A variety of graph based methods may be employed for automatically determining which nodes of FIG. 2A are more “important” than others for purpose of creating a prioritized list pre-load candidates. In one embodiment, after a graph is constructed from a predetermined set of samples (e.g., 241 of FIG. 2A), an initial set of importance weights (e.g., 235b.8, 235c.8) is assigned to the node. More specifically, in one embodiment, the initial weight value is calculated as 1/N where N is the number of connector branches (e.g., 233a) and spoke-like branches (e.g., 239) touching that node. In an alternate embodiment, the initial weight value is calculated as 1/(wc*Nc+ws*Ns) where Nc is the number of connectors (e.g., 233a) touching that node, Ns is the number of spokes (e.g., 239) touching that node, we is a weighting value attributed to join operation connectors and ws is a weighting value attributed to solo table operations (e.g., table truncates) where more specifically, in one embodiment wc>ws. In these exemplary embodiments based on reciprocal assignment (e.g., 1/N) of initial importance weight based on number of touching graph edges, those nodes with the lowest weight values are deemed most “important” and those with greater weight values are deemed proportionally less important. Note that a register overflow condition cannot be created with such a reciprocal based importance assignment system because maximum importance saturates towards zero and minimum importance cannot be greater than 1/Nmax where Nmax is a predetermined maximum number of graph edges allowed to simultaneously touch a node (a.k.a. a graph vertex).

In a next step, importance values are fractionally bequeathed from parent nodes to correspondingly created child nodes by way of the respective creation output pathways (e.g., 233g, 239a). More specifically, if a given first node has an initial weight of 1/(N₁), that weight may bud off as a fractional dividend weight 1/(2*N₁) that is to be distributed as a dividend to a respective one of that first table's children (each node may have many children because each node may participate in more than one join operation and/or more than one other table creation operation, e.g., a truncate operation). The denominators of the distributed dividends are added to the original denominators of the bequest receiving child nodes. For example if a child of the exemplary first node had an initial importance weight of 1/(N₂), its post dividend weight would become 1/(N₂+2*N₁). In other words, it would grow in importance due to inheritance of fractional importance from its parent or parents. The fraction used for fractional dividend distribution from parent nodes to child nodes may vary from one application to the next. For example, binary join operations may use a 50% dividend calculating fraction while trinary join operations may use a 33% fraction and truncate operations may use a 10% fraction. Also the inherited values of the fractional dividend distributions may vary as functions of priority values (e.g., 234a.7) assigned to the connectors or spokes through which they flow. In one embodiment, the bequeathing process may be thought of as akin to how total resistance is calculated in electrical circuit theory when resistors are combined in parallel. As more and more resistors are added, the total resistance of the parallel circuit trends towards zero. Similarly in that embodiment, as importance values are contributed to a node from elsewhere, its importance value is enhanced by trending towards zero, where zero is considered maximum importance.

The top down rippling of importance values as dividends passed from parent to child may be viewed a part of a downward directed and weighted PageRank-like process that causes child nodes to grow in importance due to importance of their parent, grandparent and/or further ancestor nodes. Then in an optional second scan that inheritance direction is reversed and importance dividends percolate upwardly from child node to parent node and so on. This indicates that parent nodes grow in importance because those parent or other ancestor nodes need to be pre-loaded so as to speed up creation of their deemed-important progeny. The upward and downward weighted PageRank-like importance bequeathing/distributing scans may be repeated a predetermined number of times or until convergence occurs to within a predetermined delta range. Note that edges can be directional and multiple edges can be found between a pair of vertices if the two corresponding tables are related in different ways. If any unidirectional relationship is involved, such as full joins, the scan process simply adds the count of the same mutually used edges onto the vertices on both sides. In such PageRank style importance inheritance distributing scans, the importance of each vertex is contributed to by its parents in the downward scan phase and each vertex splits its current importance for distribution as a fractional dividend among its children. In one embodiment of such a weighted PageRank process, each vertex contributes more weights through those of its graph edges having higher edge weights or priorities and less so through those of its graph edges having lower edge weights or priorities. In one embodiment, user preferences are considered as defining the edge weights during the PageRank computation process. The result of the PageRank style process assigns an importance score (a.k.a. page-rank or importance value) to each table (each node) that is a candidate for pre-loading. A general purpose PageRank algorithm is provided by Vince Grolmusz, “A note on the PageRank of undirected graphs”, Information Processing Letters, Volume 115, Issues 6-8, 2015, Pages 633-634, which disclosure is incorporated herein by reference.

FIG. 2A illustrates an example of downward importance distribution by way of flow arrows 233f.1d and 233f.2d respectively contributed fractional dividends acquired from nodes 231 and 232 and passed through weighted connectors 233f.1 and 233f.2 respectively child node 236. One of the operational spokes of that child node 236 may be a truncate operation that creates truncated grandchild node 259. A further downward importance distribution is depicted by distribution flow arrow 239.1d whereby node 236 passes a fractional dividend based on its current importance through weighted connectors 239, 239a to grandchild node 259. The latter node 259 may have yet further operational spokes that create yet other new tables (not shown) and where those yet other new tables may inherit from their ancestors. Although not shown it is to be understood that the flow arrows would flip 180 degrees if or when an upward PageRank style importance inheritance scan is carried out.

After the node importance determining and distributing computations are carried out, a further process is performed to determine which pre-load candidates among the importance ranked candidates (e.g., highest importance nodes or clusters of nodes) are to be considered first for placement into the memory (e.g., 167) allocated for storage of pre-loads. Referring to FIG. 2B, shown are example results of graph structures formed out of the elements of FIG. 2A and then segregated using one or more graph community detection algorithms. One example of a graph community detection algorithm is the Girvan-Newman process whose steps may be summarized as follows: (a) compute betweeness centrally for each graph edge; (b) remove edge with highest score; (c) re-compute all scores; (d) go to step (b). The computational complexity of the basic Girvan-Newman process is O(n³). However many variations and improvements have become known in the art of graph community detection, for example those that improve precision by use of different “betweeness” measurements and those that reduce computational complexity for example through use of sampling and/or local computations. It is within the contemplation of the present disclosure to use either the basic Girvan-Newman process or one of its variations and/or other forms of graph community detections to separate the graphed operations (represented by edges) and graphed tables (represented by nodes) into densely populated graph communities and sparsely populated graph communities that are further hierarchically partitionable. In one embodiment, the graph is first filtered to remove one or more types of operations (e.g., specific join operations) while keeping at least one type of operation. Then partitioning into separate graph communities is performed. The total sizes of the candidate tables in each densely populated graph community is determined. If too large, further partitioning is performed to create smaller graph communities. Then the priorities of the tables in each densely populated community are sorted and a predetermined top M ones of them are to be pre-loaded (where M is an integer for example in the range 3-20).

In one embodiment, computation of Graph density for purposes of partitioning and identifying highest density communities or sub-communities can proceed per the following:

The density of a candidate graph community or sub-graph, G=(V,E,W) is used to measure overall weights of the pre-weighted vertices and pre-weighted edges in the candidate set E as compared to the overall weights of the vertices and the maximum possible number of edges between vertices in a larger normative set V:

$${d}_{G ( V , E , W )} = \frac{{\sum }_{( u , v ) ∈ E} f ( {w}_{u} , {w}_{v} , {w}_{u , v} )}{{\sum }_{u , v ∈ V , u \neq v} f ( {w}_{u} , {w}_{v} , {w}_{u , v} )}$$

Here the function f( ) combines the weights on vertices u, v and on edge (u, v). In one embodiment, the function f( ) is defined as a combinatory by:

$$f ( {w}_{u} , {w}_{v} , {w}_{u , v} ) = \frac{{w}_{u} + {w}_{v}}{2} \cdot {w}_{u , v}$$

Note that the above example does not consider the scenario where multiple edges exists between two vertices, nor the scenario where an edge out-coming from a vertex goes back to a same vertex (cycle). Also note that a partitioned community or sub-community in a graph is essentially a sub-graph. When there is no weight for vertices (and/or edges), the operation can be simplified so as to let wᵤ=wᵥ=1 (and/or w_{u,v}=1). Then, the above density computation degrades into

d=|E|/(|V|*(|V|−1))

where |V| and |E| are the numbers of vertices and edges, respectively, in graph G(V,E,W).

It is to be noted that the above computation of sub-graph density is merely one example. Numerous alternatives can be devised for identifying sub-graphs of highest importance for specific goals associated with predictive pre-processing (e.g., pre-loading and/or pre-computing). For example, enhanced weights may be automatically attributed to operation-representing edges (graph branches) if the represented operations have comparatively higher frequencies of occurrence in source code and/or in actual execution of the corresponding machine code in predetermined recent time periods and/or if the represented operations have comparatively higher urgencies. Similarly, enhanced weights may be automatically attributed to table-representing vertices (graph nodes) if the represented tables have comparatively higher frequencies of occurrence in source code and/or in actual execution of the corresponding machine code in predetermined recent time periods. Such weight enhancement can tilt graph density computations to favoring one or another of possible goals of automated pre-load and/or automated pre-compute plannings.

The example of FIG. 2B shows that a first densely populated graph community 271 has been separated by a graph community detection process from second and third sparsely populated communities 273 and 274 as well as from yet another densely populated community 272. The higher densities of dense communities 271 and 272 may be attributable to core nodes such as 271c that have highest importance scores and that are typically are touched on by a relatively large number of branches (connectors or spokes) and/or attributable to highly probability or high frequency or high urgency ones of attached operations (e.g., represented by short or thick graph branches) as opposed to operations predicted to have substantially lower probabilities of execution and/or result usage and/or result urgency. An example of an operation predicted to have a high probability of execution and repeated use and/or predicted to have a relatively high urgency of quick accessibility is represented in block 271b by the comparatively thickened connector line of a given joint type. Nodes with thickened borders such as at 271a and 271c represent tables that have higher importance scores due to Page Ranking-like inheritance and/or due to being touched on by a number of branches (graph edges) greater than a predetermined threshold (e.g., three or more) and/or by branches having one or more weights representing desirability of their results being quickly available due to urgency or other factors. It is understood that in FIG. 2B, not all branches and nodes are shown so that illustrative clutter is thereby avoided.

The example illustrated at 273 is that of a sparsely populated graph community. Community detection may determine that a respective community (e.g., 273) is a separate community even though the latter may have one or more above-threshold nodes of importance (e.g., 273a) and/or even though the latter may have one or more above-threshold probabilities of the operation execution (e.g., thick branch inside 273b). The determination may instead be based on detection of other nodes (e.g., 273c) that are not touched by a sufficient number of branches (e.g., 273d) and/or are not touched by operation-representing branches of sufficient probability of execution (e.g., thin lines inside 273d).

It is to be understood that the boundaries of the graph communities (sub-graphs) may be altered after being initially defined. For example, the table of node 272a may be the result of a join output spoke 2710 of a join connector 271d initially placed inside graph community 271. However, it may be discovered that the table of node 272a is too large to use and it is preferable to pre-store the smaller tables (not shown) of join connector 271d as partial pre-join results belonging inside the boundary of graph community 272. In other words, node 272a is broken apart or partitioned into precursor nodes representing smaller sized tables and the representative nodes for those smaller sized tables are moved into or copied into the boundaries of graph community 272 thereby altering graph community 272. Usage for such a modification will be described further below.

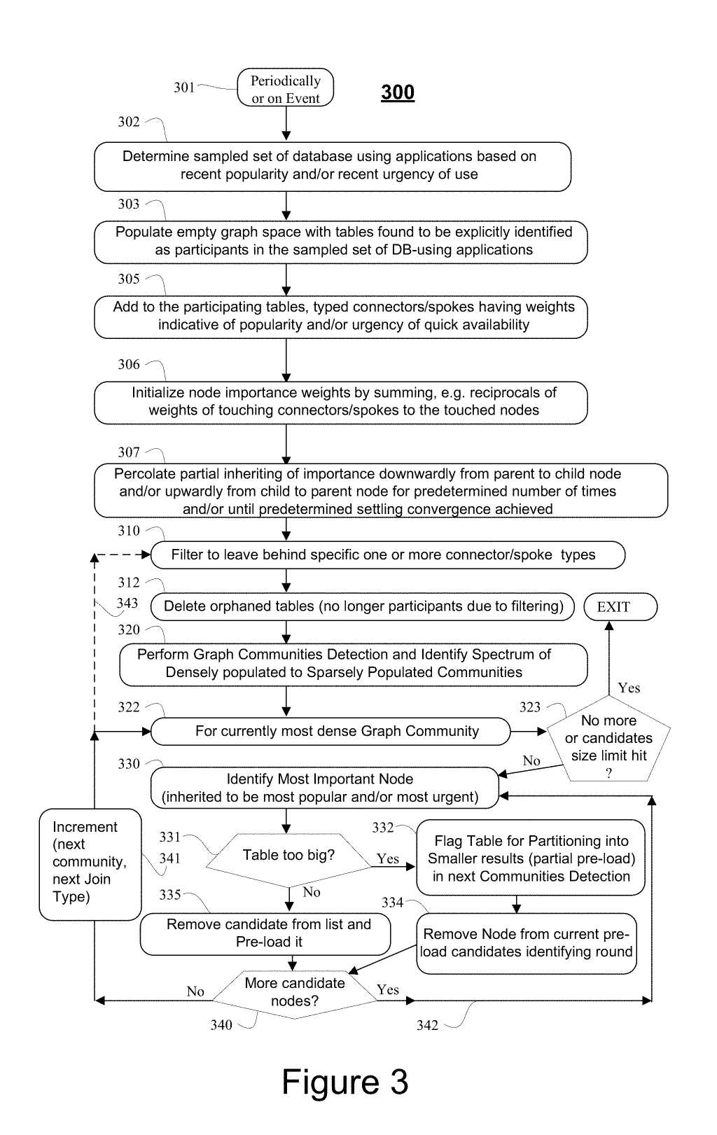

Referring to the flow chart of FIG. 3, a process 300 in accordance with the present disclosure is now described. Entry into process 300 may be made at step 301 on a periodic and/or event driven basis. The periodicity of entry at 301 may be reflective of time durations over which enterprise usage patterns change or situations in the external world (ROTW 110) typically change; for example on a biweekly basis or on financial quarterly report bases. Events that trigger entry at 301 may include unusual financial events or world news events such as major increases or decreases in valuations of financial instruments; release of disruptive technologies; beginnings or terminations of belligerent activities and so on.

At step 302, a determination is made as to which database-using applications (e.g., queries) are to be considered as part of a sample set (e.g., that of 241 in FIG. 2A) based for example on recent popularity of usage of those applications and/or based on recent urgency for quick results from those applications.

At step 303, an empty graph space is populated with nodes respectively representing tables that are found to be explicitly identified as aggregation or other operation participants in the sampled set of DB-using applications (e.g., 141-143). At step 305, the spaces between the nodes of the respective participant tables are populated by corresponding, typed connectors and/or spokes that each have weights indicative of popularity and/or urgency of quick availability of the represented table referencing operations.

At step 306, an initialization operation is carried out that transfers a function of the weights of the connectors and/or spokes (graph edges) to their respectively touched nodes (graph vertices). In one embodiment, that function adds the reciprocals of the weights to thereby assign initial importance values to the correspondingly touched nodes. A zero importance value indicates maximum importance while importance values progressively greater than zero respectively indicate nodes of progressively lesser importance. This scheme avoids a function that can overflow the computer's registers as importance value grows. Other functions for representing importance can of course be used. The summed reciprocals method is merely an example.

At step 307, the initial importance values percolated down and/or up the graph by way of partial inheritance as explained above. When both of downward percolation and upward percolation are used in said order, child nodes first inherit (as enhancements to their own initial importance) the importance of their respective parent nodes. Then in the upward percolation phase, parent nodes inherit (as enhancements to their own current importance) the importance of their respective child nodes. This is repeated a predetermined number of times and/or until a predetermined degree of convergence on steady state values is achieved. The predetermined degree of convergence can specify for example that importance values have not changed by more than a predetermined percentage (e.g., 10%) in the last upward or downward percolation.

At step 310, the graph results are optionally filtered to leave behind connectors and/or spokes of a prespecified one or more types of table referencing operations; for example only those of left, right, and full joins. Then, at step 312, orphaned tables which no longer have any connectors or spokes touching them, meaning they are no longer participants in any table referencing operation among the types being considered; are removed from the graph.

At step 320, a graph community detection process such as the above mentioned Girvan-Newman process and variations thereof is performed to thereby identify a spectrum of graph communities spanning from those that are densely populated to those that are sparsely populated. The densely populated communities are separated out from the sparsely populated ones. It is understood here that the densely populated graph communities each represent a compilation of referenced tables of a given one or more types (as pre-filtered at steps 310-312) which have the relatively highest levels of importance due to the number of table referencing operations predicted to be performed on them, due to the popularity of usage and/or urgency of access to quick results by those operations and due to parent-child relationship between important children and thus, by reverse inheritance, important parent nodes. By contrast, the sparsely populated graph communities each represent individual or compilations of tables which do not have many table referencing operations attributed to them and do not have important parents or important children, this indicating less of a benefit from pre-loading the tables of such lesser importance nodes.

Prior to step 322, the isolated graph communities are sorted so as to list the densest most such community first. Step 322 is part of a loop (carried forward from step 341) which increments through each of the progressively less dense graph communities. (A test carried out at step 323 and described later determines when the loop ends.) At step 330 and for the currently most dense graph community, an identification is made of the most important (e.g., highest PageRanked) node found within that densest candidate community; where the density of the identified node indicates that it is a relatively most popular and/or most urgently referenced of the table-representing nodes or is needed for producing important children within the current community and thus may be worthy of pre-loading.

At step 331, an estimate is made of the size of the candidate table as it would be created if the represented table-referencing operation (e.g., a conditional join operation) were performed. In the illustrated process, it is understood that a finite amount of storage has been set aside (allocated) for pre-loading the important tables and that some of the important tables may be too large relative to a predetermined limit on size for pre-loading. System administrators may have decided that it is preferable to pre-load a greater number of smaller tables or relatively large importance rather than just one extra large table of higher importance due to cost versus benefit analysis. These preferences may be reflected in the rules of a knowledge database used for automatically making such determinations as well as determination of where in a storage hierarchy such as 167 the pre-load candidate is to be placed. If the outcome of the size test at step 331 is yes, meaning the estimated size of the table is too large, control passes to step 332 where the to-be-bypassed participating table(s) is/are flagged for inclusion in a later-to-be-carried out partitioning operation where one or both of operation participant tables are broken apart or partitioned into smaller tables whose joint or other table-referencing results can be accepted in a later round of community detection. Then at step 334, the candidate node whose expected size was deemed too large, even though relatively important, is removed from a current list of pre-load candidates. At subsequent test step 340 it is determined whether there are more high importance candidate nodes (e.g., pre-sorted according to importance) left to consider. If there are no more candidates, path 341 is taken in which there is an increment to the next graph community or to a next table-referencing operation type. On the other hand, if more candidates are left behind, path 342 is taken back to step 330 where the next most important node is considered.

If the result of test step 331 indicates that the estimated table size is not too big, then control continues to step 335 where the corresponding node is appended to a current pre-loads candidates list and the considered candidate is removed from the graph. This is followed by continuation into test step 340. If all the more important nodes of a first graph community are exhausted at test step 340, then incrementing step 341 advances to the next graph community and if all those are exhausted then extension path 343 allows the system to repeat the process for a different subset of table-referencing operation types if filtering was performed in optional steps 310 and 312.

As incrementing to a next densest graph community is carried out at step 322, a loop terminating test 323 is first carried out to determine if there are any more candidate graph communities and/or if a memory capacity limit has been hit for the pre-allocated amount of storage that has been dedicated for pre-load results. If there are no more candidates or the capacity limit has been hit the process exits at the indicated EXIT step.

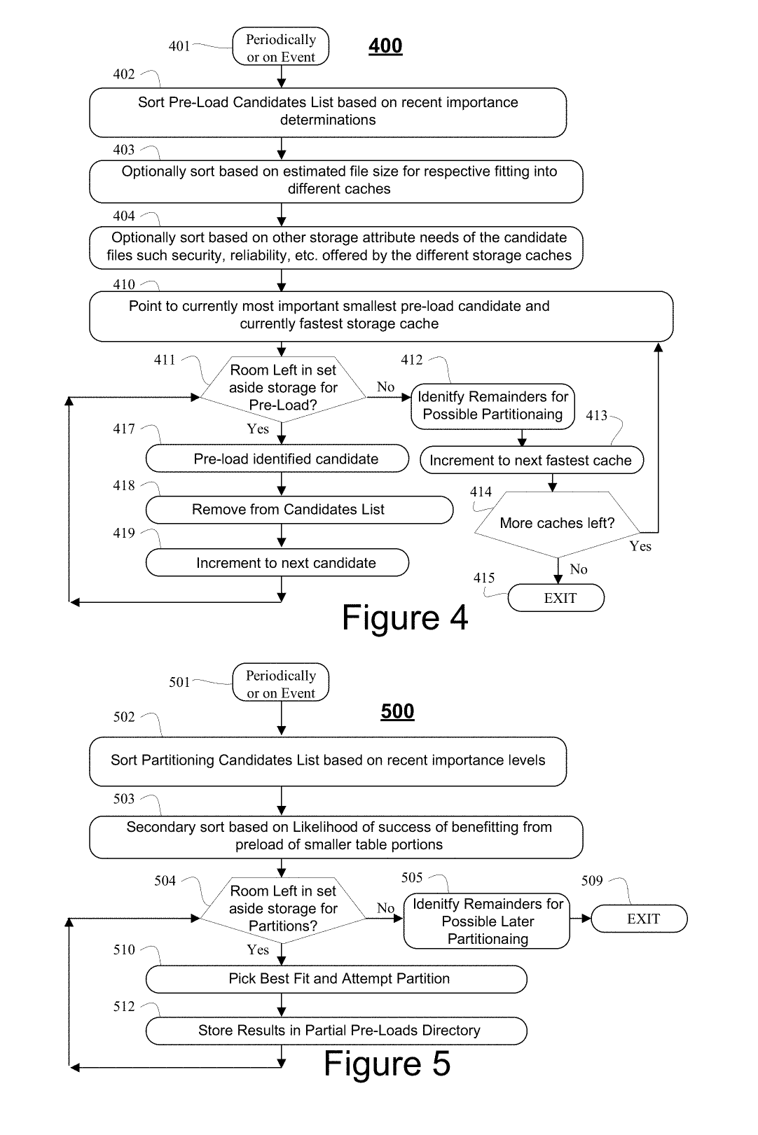

Referring to FIG. 4, shown is a flow chart for a process 400 in which the planned pre-loadings are performed. Entry is made periodically and/or on an event driven basis at step 401. In steps 402-404, a number of sorting steps are performed. The indicated sorts need not be performed in the illustrated order and the results may be stored in a database which allows for keying on one or more of the sort parameters. The first illustrated sort at step 402 orders the pre-load candidates according to the most recent importance determinations. The second sort at step 403 orders them according to expected or estimated file size. This is done for determining which candidates are best fitted into which types of different caches, for example large slower ones mall or faster ones. The third sort at step 404 orders the candidates according to other attribute needs such as storage security and/or storage reliability in cases where the available storage hierarchy (e.g., that of FIG. 1C) provides for differentiation according to storage attributes beyond that of size and speed.

After sorting is complete, at step 410, the process points to the currently most important and smallest of the preload candidates and also to the currently fastest (and generally smallest) of the storage caches.

At step 411 it is determined whether there is a practical amount of room still left in the currently pointed to storage cash for preloading the current candidate. If yes, control passes to step 417 where the pointed to preload candidate is preloaded in to the current cache. At step 418 that preloaded candidate is removed from the candidates list. At step 419 the process increments to point to the next candidate in the sorted list of candidates (e.g., sort is from smallest most important to largest and least important). Control then returns to step 411 for determining whether there is room for that next candidate.

If the answer to test step 411 is no, there is not enough room, control passes to step 412. Here optionally, remaining candidates within a class of larger but more important ones are identified for possible breakup into smaller pieces, some of which may qualify for preloading in a next round. In next step 413 the process increments to point to the next fastest (and generally next larger) cache. If test step 414 determines that are no further caches to increment to an exit is taken at step 415.

On the other hand, if there is a next fastest (and generally next larger) cache two point to, then that next cash is designated as the current cash and control returns to step 410. The process repeats until all the most important and progressively larger files are fitted into the progressively slower and progressively larger available caches.

Referring to FIG. 5, shown is a process 500 for trying to fit in partial preloads in cases where such partial preloads may provide performance benefit. Entry is made periodically or on a predetermined event at step 501. At step 502, a previously created list of partitioning candidates is sorted according to recently determined importance levels.

At step 503 and analysis is performed to determine likelihood of success in benefiting from preloading smaller portions of the candidate tables (e.g., truncated portions) into a fast cache and then during runtime obtaining the rest of the table from a slower memory source. The best candidate for such benefit is pointed to first. Then at step 504 it is determined whether there is room left in a set-aside storage area for such partitions for the current candidate. If yes, then at step 510 and attempt is made to partition (e.g., form a truncation of) the currently pointed to candidate. If successful the results are stored into the partial preloads storage at step 512 and a corresponding entry is made into a partial preloads directly. Control then returns to step 504.

If test step 504 determines that there is currently no more room, the candidates that were left behind are identified in step 505 four possible later processing in case free space is created within the set-aside storage area for such partitions. Then an exit is taken at step 509.

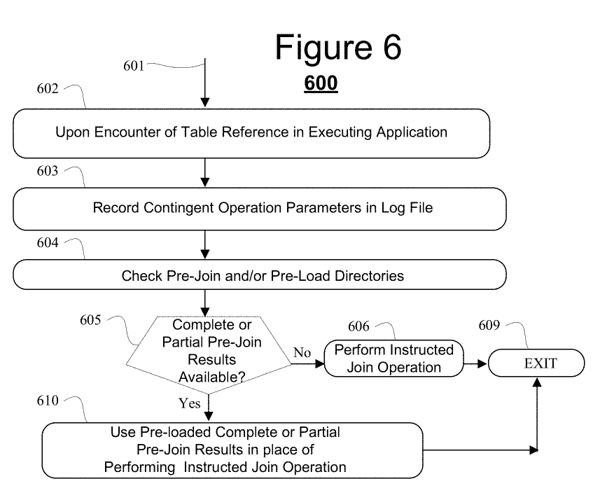

Referring to FIG. 6, a machine automated method 600 is illustrated for processing table-referencing operations during runtime. The purpose of this method 600 is primarily for creating the history logs used during graph generation. At step 602, upon encountering a reference to a table in an executing application, control is passed to step 603. In step 603 various operational parameters that are indicative of the table referencing operation completing are stored into a corresponding preload and/or pre-join log file so that later on it may be determined what the likelihood is of the same operation successfully completing each time the application is run.

At step 604, a check is made of current pre-join and/or pre-load directories to determine if a preload or other preprocessing of the desired information is available in fast cache, and if so where it is located. At step 605, if the directories indicate that a complete or partial pre-join result is available for speeding up a corresponding pre-join operation, then at next step 610 the pre-loaded complete or partial pre-join results are used in place of performing an entire join operation while fetching data from slower storage. Then an exit is made at step 609. On the other hand, if a pre-compute result is not already available, then the current file aggregation operation is performed at step 606 and then exit is taken at step 609.

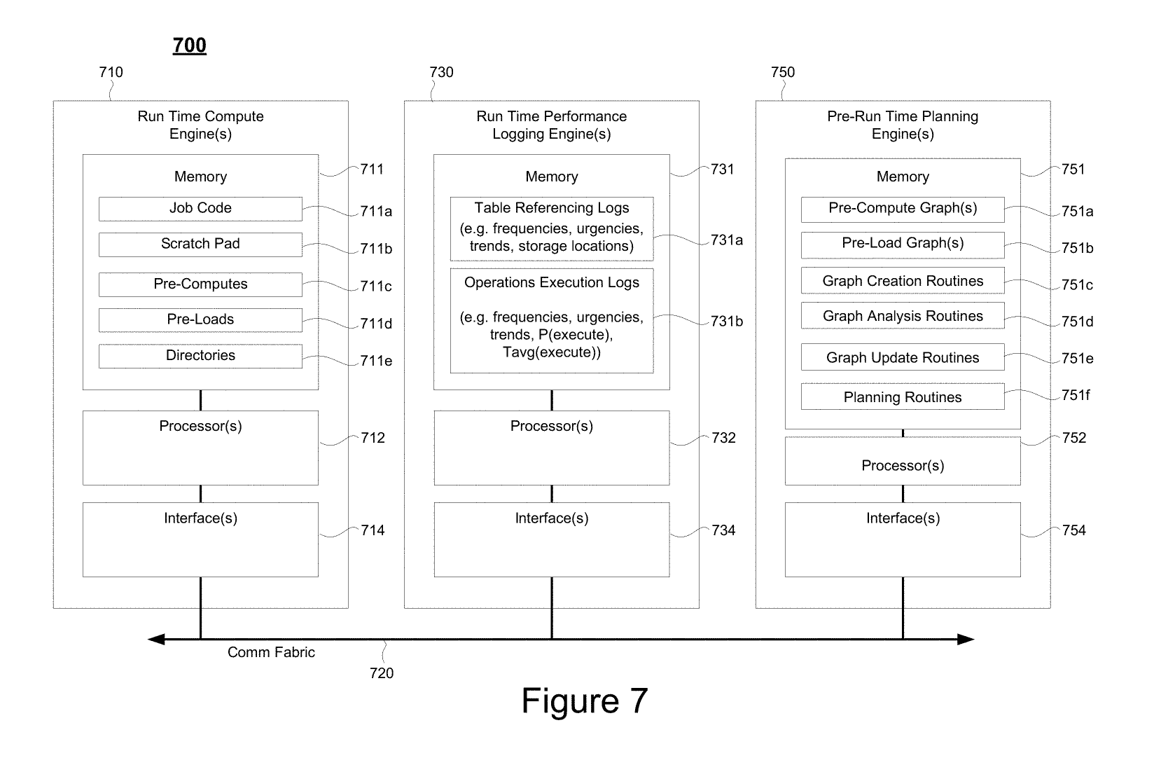

FIG. 7 is a block diagram 700 depicting three types of operatively interconnected automated engines of a system in accordance with the present disclosure. The interconnected engines include one or more run time computational engines 710, one or more run time performance logging engines 730, and one or more pre-run time planning engines 750. The engines 710, 730 and 750 are operatively coupled to one another by way of a common communications fabric 720. The latter fabric may include wireless and/or wired communication resources. Appropriate interfaces 714, 734 and 754 are provided in the respective engines 710, 730 and 750 for communicating by way of the fabric 720. Although not shown, it is to be understood that the communications fabric 720 may extend to operatively communicate with other parts of the partially shown system 700 including one or more pre-load engines (e.g., 14 of FIG. 1A), one or more pre-compute engines (e.g., 29 of FIG. 1A), data fetching engines (e.g., 12) coupled to a big data base (11) and a jobs dispatcher (e.g., 40).

Each of the illustrated engines 710, 730 and 750 includes a respective memory subsystem 711, 731 and 751 configured for storing executable code and data usable by a respective set of one or more processors (712, 732 and 752) of that respective engine. For sake of simplicity and avoiding illustrative clutter, not all the executable codes and in-memory data are shown.

Each run time computational engine 710 may contain job code 711a loaded by the dispatcher into its memory 711. Blank memory space 711b (a.k.a. scratch pad space) may be set aside for computational needs of the dispatched job code 711a. The job code 711a may include machine code and/or higher level code (e.g., SQL code). Pre-planned for and already pre-computed results (e.g., pre-joins) may be stored in a memory space 711c allocated for storing such pre-computes. Pre-planned for and already pre-loaded data (e.g., DB tables) may be stored in a memory space 711d allocated for storing such pre-loads. Lookup tables and/or directories 711e may be generated for identifying and located the stored pre-computes 711c and stored pre-loads 711d.

During run time execution of the job code 711a, an associated run time performance monitoring and logging engine 730 keeps track of how well the job executes. Among the monitored and logged performance parameters are indicators of which pre-computes 711c are used (also how often) and which merely waste storage space in region 711c because they are never used or used extremely infrequently. Other performance parameters may identify run time computes that should have been stored in the pre-computes area 711c (e.g., because they consumed too much of run time resources) but were not and also how often or how urgently they were needed by respective jobs. Yet others of the monitored and logged performance parameters may identify run time data fetches that should have been but were not stored as pre-loads in area 711d. Further indicators may identify which pre-loads are used (also how often) and which merely waste storage space in region 711d because they are never used or used extremely infrequently. Memory area 731a collects statistics (e.g., trending data) over many a run jobs with respect to pre-loading based on how many times and/or with what frequency corresponding DB tables were referenced, with what urgencies, table sizes, from which types of storage locations (e.g., fast, slow). Memory area 731b collects statistics over many a run jobs with respect to pre-computes based on how many times and/or with what frequency corresponding operations (e.g., pre-joins) were executed or contingently executed, what were the probabilities of execution (P(execute)) for each operation or kind of operation, what were the average run times (Tavg(execute)) to completion if completed, what were the completion urgencies and so forth. If multiple run time performance monitoring and logging engines 730 are involved, their individually generated logs may be collected into a central repository. In one embodiment, the multiple run time performance monitoring and logging engines 730 are respective allocated to different departments or other organizational units of an enterprise (e.g., 150 of FIG. 1E) so that performance feedback information can be collected on a per department/organization basis as well as for the whole enterprise.

After run time execution of a predetermined number of jobs and/or periodically, the feedback information collected by one or more of the run time performance monitoring and logging engines 730 is communicated to a corresponding one or more of the pre-run time planning engines 750 prior to execution of a next batch of jobs. The latter engines 750 contain graph creation routines 751c and/or graph update routines 751e configured for generating performance modeling graphs such as shown for example in FIGS. 1D and 2A. Generated graphs may be respectively stored in a pre-compute graphs storing area 751a and a pre-load graphs storing area 751b. The pre-run time planning engines 750 further contain graph analysis routines 751d configured for analyzing the various graphs including on the basis of identifying graph communities having respective vertex and/or edge densities. The pre-run time planning engines 750 may additionally contain planning routines configured for using the results of the graph analysis routines 751d to formulate pre-load and/or pre-compute (e.g., pre-join) instructions that are to be carried out respectively by appropriate pre-load and pre-compute engines (e.g., 14 and 29 of FIG. 1A) prior to or during runt time execution of a next batch of jobs. In this way the system is automatically and repeatedly updating its pre-load and pre-compute operations to adaptively maintain efficiency and job execution speed even as circumstances change.

Computer-readable non-transitory media described herein may include all types of non-transitory computer readable media, including magnetic storage media, optical storage media, and solid state storage media and specifically excludes transitory signals and mere wires, cables or mere optical fibers that carry them. It should be understood that the software can be installed in and sold with the pre-compute and/or pre-load planning subsystem. Alternatively the software can be obtained and loaded into the pre-compute and/or pre-load planning subsystem, including obtaining the software via a disc medium or from any manner of network or distribution system, including, for example, from a server owned by the software creator or from a server not owned but used by the software creator. The software can be stored on a server for distribution over the Internet, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for identifying database tables to be pre-loaded into local storage, the method comprising:
generating a graph having edges and nodes, wherein each node represents a respective table and each edge represents a respective table referencing operation;
computing a respective importance value for each of the nodes, the importance value being indicative of at least one of how many operations are predicted to reference each respectively represented table, weights of frequency and/or urgency pre-assigned to the operations represented by node-contacting edges, or pre-computed importance values of ancestors or progeny nodes of each respective node within the graph;
partitioning the recorded graph into a plurality of graph communities having respective densities, the densities being indicative of each respective graph community having one or more nodes of relatively high importance; and
identifying, as preferred candidates for pre-loading, the tables represented by those of the nodes having a greater importance as compared to importance values computed for other nodes in the partitioned graph.

2. The method of claim 1 wherein the represented tables include those that are participants in multi-table referencing operations.

3. The method of claim 2 wherein the weights of respective ones of the edges is based on metadata associated with the respective edges, the metadata indicating at least one of a join type, join dynamics, probability of the join being referenced, geometry of the join, directional aspect of the join, frequency of reference to the join results, historical trends in frequency of reference to the join results and urgency priority for having the join results immediately available.

4. The method of claim 3 wherein the associated metadata of respective ones of the edges provide a unique identification for the corresponding edge and/or its represented set of one or more join operations.

5. The method of claim 3 wherein the associated metadata of respective ones of the edges identify the tables joined by the respective edge.

6. The method of claim 1 wherein the nodes are respectively associated with corresponding node metadata, the node metadata indicating at least one of a unique node identification, an identification of a table represented by the node, an identification of a table type, an indication of the table size, an indication of maximal extents in different aspect dimensions of axes of the table, an indication of how persistent the table needs to be within memory and an indication of a desired access speed for accessing the table.

7. The method of claim 1 and further comprising:
before said partitioning of the produced graph performing at least one of:
filtering the produced graph, with one or more processors, to leave behind only edges representing a specific one or more of different operation types; or
filtering the produced graph, with one or more processors, to leave behind only nodes representing a specific one or more of different types of tables.

8. The method of claim 1 wherein the identifying of the preferred candidates comprises:
ordering detected graph communities according to their graph densities, where the densities are indicative of collective importance of nodes therein, frequency of referencing to the members of the community and/or indicative of collective urgency of access to the members of the community; and
identifying a densest one of nodes within one of the ordered graph communities.

9. The method of claim 8 and further comprising:
sequencing from one of the ordered graph communities to the next based on said ordering.

10. The method of claim 1 wherein the identifying of the preferred candidates comprises:
determining if a pre-load candidate is larger than a predetermined threshold, and if true, designating the corresponding pre-load candidate for partitioning into smaller sequential predictive pre-processing candidates.

11. A data processing system comprising:
memory storage comprising instructions; and
one or more processors in communication with the memory, wherein the one or more processors execute the instructions to:
generate a graph having edges and nodes, wherein each node represents a respective table and each edge represents a respective table referencing operation;
compute a respective importance value for each of the nodes, the importance value being indicative of at least one of how many operations are predicted to reference each respectively represented table, weights of frequency and/or urgency pre-assigned to the operations represented by node-contacting edges, or pre-computed importance values of ancestors or progeny nodes of each respective node within the graph;
partition the recorded graph into a plurality of graph communities having respective densities, the densities being indicative of each respective graph community having one or more nodes of relatively high importance; and
identify, as preferred candidates for pre-loading, the tables represented by those of the nodes having a greater importance as compared to importance values computed for other nodes in the partitioned graph.

12. The system of claim 11 wherein the represented tables include those that are participants in multi-table referencing operations.

13. The system of claim 12 wherein the weights of respective ones of the edges is based on metadata associated with the respective edges, the metadata indicating at least one of a join type, join dynamics, probability of the join being referenced, geometry of the join, directional aspect of the join, frequency of reference to the join results, historical trends in frequency of reference to the join results and urgency priority for having the join results immediately available.

14. The system of claim 13 wherein the associated metadata of respective ones of the edges provide a unique identification for the corresponding edge and/or its represented set of one or more join operations.

15. The system of claim 13 wherein the associated metadata of respective ones of the edges identify the tables joined by the respective edge.

16. The system of claim 11 wherein the nodes are respectively associated with corresponding node metadata, the node metadata indicating at least one of a unique node identification, an identification of a table represented by the node, an identification of a table type, an indication of the table size, an indication of maximal extents in different aspect dimensions of axes of the table, an indication of how persistent the table needs to be within memory and an indication of a desired access speed for accessing the table.

17. The system of claim 11 and wherein the one or more processors execute the instructions to:
before said partitioning of the produced graph, perform at least one of:
filter the produced graph, with one or more processors, to leave behind only edges representing a specific one or more of different operation types; or
filter the produced graph, with one or more processors, to leave behind only nodes representing a specific one or more of different types of tables.

18. The system of claim 11 wherein the one or more processors execute the instructions to:
order detected graph communities according to their graph densities, where the densities are indicative of collective importance of nodes therein, frequency of referencing to the members of the community and/or indicative of collective urgency of access to the members of the community; and
identify a densest one of nodes within one of the ordered graph communities.

19. The system of claim 18 wherein the one or more processors execute the instructions to:
sequencing from one of the ordered graph communities to the next based on said ordering.

20. The system of claim 11 wherein the one or more processors execute the instructions to:
determine if a pre-load candidate is larger than a predetermined threshold, and if yes, designating the corresponding pre-load candidate for partitioning into smaller sequential predictive pre-processing candidates.

21. A non-transitory computer-readable medium storing computer instructions, that when executed by one or more processors, cause the one or more processors to perform the steps of:
generate a graph having edges and nodes, wherein each node represents a respective table and each edge represents a respective table referencing operation;
compute a respective importance value for each of the nodes, the importance value being indicative of at least one of how many operations are predicted to reference each respectively represented table, weights of frequency and/or urgency pre-assigned to the operations represented by node-contacting edges, or pre-computed importance values of ancestors or progeny nodes of each respective node within the graph;
partition the recorded graph into a plurality of graph communities having respective densities, the densities being indicative of each respective graph community having one or more nodes of relatively high importance; and
identify, as preferred candidates for pre-loading, the tables represented by those of the nodes having a greater importance as compared to importance values computed for other nodes in the partitioned graph.
